(19) United States
(12) Patent Application Publication
(10) Pub. No.: US 2023/0214469 A1
(43) Pub. Date: Jul. 6, 2023

(54) INFORMATION PROCESSING APPARATUS, INFORMATION PROCESSING METHOD, AND STORAGE MEDIUM

(71) Applicant: NEC Corporation, Minato-ku, Tokyo (JP)

(72) Inventors: Sojiro HAYASHI, Tokyo (JP); Kazuhisa ORITA, Tokyo (JP); Xiujun BAI, Tokyo (JP)

(73) Assignee: NEC Corporation, Minato-ku, Tokyo (JP)

(21) Appl. No.: 18/009,012

(22) PCT Filed: Jun. 11, 2020
(86) PCT No.: PCT/JP2020/022992

§ 371 Date: Dec. 8, 2022

(51) Int. Cl. G06F 21/32; G06V 40/50; G06V 40/16; G06V 10/82

(52) U.S. Cl. CPC G06F 21/32; G06V 10/82; G06V 40/50; G06V 40/172; G06F 2221/2117

(57) ABSTRACT

According to this disclosure, there is provided an information processing apparatus including: an acquisition unit that acquires, from a subject to be registered, a plurality of biometric information whose type differ from each other; a specifying unit that specifies, based on features of each of the plurality of biometric information, a category to which each of the plurality of the biometric information belongs, among a plurality of categories set for each of the types; and a registration unit that registers, in the storage area in association with each of the subjects to be registered, the plurality of biometric information and the categories to which the plurality of biometric information belong respectively.

### TECHNICAL FIELD

This disclosure relates to an information processing apparatus, an information processing method, and a storage medium.

### BACKGROUND ART

PTL 1 discloses an authentication device that authenticates a user on the condition that two types of biometric information (finger vein information and fingerprint information) acquired from the user and two types of registered biometric information pre-registered in an authentication database for the registrant match for each type.

### CITATION LIST

### Patent Literature

PTL 1: Japanese Patent Laid-Open No. 2006-155252

### SUMMARY OF INVENTION

### Technical Problem

In multimodal biometric authentication as exemplified in PTL 1, it is necessary to perform a matching process for each type of biometric information between a user who is a subject to be matched and the registrant of the authentication database. For this reason, there is a problem that the matching speed would slow down if the number of registrants in the authentication database became large.

Therefore, in view of the above problems, an object of this disclosure is to provide an information processing apparatus, an information processing method, and a storage medium that can improve the matching speed in multimodal biometric authentication.

### Solution to Problem

According to one aspect of this disclosure, there is provided an information processing apparatus including: an acquisition unit that acquires, from a subject to be registered, a plurality of biometric information whose type differ from each other; a specifying unit that specifies, based on features of each of the plurality of biometric information, a category to which each of the plurality of the biometric information belongs, among a plurality of categories set for each of the types; and a registration unit that registers, in the storage area in association with each of the subjects to be registered, the plurality of biometric information and the categories to which the plurality of biometric information belong respectively.

According to another aspect of this disclosure, there is provided an information processing method including: acquiring, from a subject to be registered, a plurality of biometric information whose type differ from each other; specifying, based on features of each of the plurality of biometric information, a category to which each of the plurality of the biometric information belongs, among a plurality of categories set for each of the types; and registering, in the storage area in association with each of the subjects to be registered, the plurality of biometric information and the categories to which the plurality of biometric information belong respectively.

According to another aspect of this disclosure, there is provided a storage medium storing a program an information processing method, the information processing method including: acquiring, from a subject to be registered, a plurality of biometric information whose type differ from each other; specifying, based on features of each of the plurality of biometric information, a category to which each of the plurality of the biometric information belongs, among a plurality of categories set for each of the types; and registering, in the storage area in association with each of the subjects to be registered, the plurality of biometric information and the categories to which the plurality of biometric information belong respectively.

According to another aspect of this disclosure, there is provided an information processing apparatus including: an acquisition unit that acquires, from a subject to be matched, a plurality of biometric information whose type differ from each other; a specifying unit that specifies, based on features of each of the plurality of biometric information, a category to which each of the plurality of the biometric information belongs, among a plurality of categories set for each of the types; and a matching unit that determines a matching destination based on the specified categories by the specifying unit, and performs a matching process between the plurality of biometric information and the plurality of registered biometric information of the registrant for each of the types.

According to another aspect of this disclosure, there is provided an information processing method including: acquiring, from a subject to be matched, a plurality of biometric information whose type differ from each other; specifying, based on features of each of the plurality of biometric information, a category to which each of the plurality of the biometric information belongs, among a plurality of categories set for each of the types; and determining a matching destination based on the specified categories, and performing a matching process between the plurality of biometric information and the plurality of registered biometric information of the registrant for each of the types.

According to another aspect of this disclosure, there is provided a storage medium storing a program an information processing method, the information processing method including: acquiring, from a subject to be matched, a plurality of biometric information whose type differ from each other; specifying, based on features of each of the plurality of biometric information, a category to which each of the plurality of the biometric information belongs, among a plurality of categories set for each of the types; and determining a matching destination based on the specified categories, and performing a matching process between the plurality of biometric information and the plurality of registered biometric information of the registrant for each of the types.

### BRIEF DESCRIPTION OF DRAWINGS

FIG. 1 is a schematic diagram showing an overall configuration of a biometric authentication system according to a first example embodiment.

FIG. 2 is a block diagram showing a hardware configuration of a biometric image acquisition apparatus according to the first example embodiment.

FIG. 3 is a block diagram showing a hardware configuration of a management server according to the first example embodiment.

FIG. 4 is a diagram showing an example of information stored in a biometric information DB according to the first example embodiment.

FIG. 5 is a diagram showing an example of information stored in a fingerprint category information DB according to the first example embodiment.

FIG. 6 is a diagram showing an example of information stored in an iris category information DB according to the first example embodiment.

FIG. 7 is a diagram showing an example of information stored in a face category information DB according to the first example embodiment.

FIG. 8 is a diagram showing an example of information stored in a registration destination information DB according to the first example embodiment.

FIG. 9 is a functional block diagram of the biometric authentication system according to the first example embodiment.

FIG. 10A is a flow chart showing an outline of a registration process performed by the biometric authentication system according to the first example embodiment.

FIG. 10B is a flow chart showing the outline of the registration process performed by the biometric authentication system according to the first example embodiment.

FIG. 11A is a flow chart showing an outline of a matching process performed by the biometric authentication system according to the first example embodiment.

FIG. 11B is a flow chart showing the outline of the matching process performed by the biometric authentication system according to the first example embodiment.

FIG. 11C is a flow chart showing the outline of the matching process performed by the biometric authentication system according to the first example embodiment.

FIG. 11D is a flow chart showing the outline of the matching process performed by the biometric authentication system according to the first example embodiment.

FIG. 12 is a diagram showing an example of a matching result in the biometric authentication system according to the first example embodiment.

FIG. 13 is a diagram showing an example of information stored in the face category information DB according to a second example embodiment.

FIG. 14 is a flow chart showing an outline of an update process performed by the biometric authentication system according to the second example embodiment.

FIG. 15 is a functional block diagram of the biometric authentication system according to a third example embodiment.

FIG. 16 is a flow chart showing an outline of an output process of alert information performed by the biometric authentication system according to the third example embodiment.

FIG. 17 is a functional block diagram of the biometric authentication system according to a fourth example embodiment.

FIG. 18 is a schematic diagram showing an example of a neural net used for a learning process by a learning unit according to the fourth example embodiment.

FIG. 19 is an example of a comparison table of face categories and matching ranges according to the fourth example embodiment.

FIG. 20 is a flow chart showing part of the matching process performed by the biometric authentication system according to the fourth example embodiment.

FIG. 21A is a flow chart showing an outline of the matching process performed by the biometric authentication system according to a fifth example embodiment.

FIG. 21B is a flow chart showing the outline of the matching process performed by the biometric authentication system according to the fifth example embodiment.

FIG. 21C is a flow chart showing the outline of the matching process performed by the biometric authentication system according to the fifth example embodiment.

FIG. 21D is a flow chart showing the outline of the matching process performed by the biometric authentication system according to the fifth example embodiment.

FIG. 22 is a functional block diagram of the information processing apparatus according to a sixth example embodiment.

FIG. 23 is a functional block diagram of the information processing apparatus according to a seventh example embodiment.

FIG. 24 is a functional block diagram of the information processing apparatus according to a tenth example embodiment.

FIG. 25 is a functional block diagram of the information processing apparatus according to an eleventh example embodiment.

FIG. 26 is a functional block diagram of the information processing apparatus according to a twelfth example embodiment.

FIG. 27 is a functional block diagram of the information processing apparatus according to a fifteenth example embodiment.

FIG. 28 is a functional block diagram of the information processing apparatus according to a seventeenth example embodiment.

FIG. 29 is a functional block diagram of the information processing apparatus according to a twenty-first example embodiment.

FIG. 30 is a functional block diagram of the information processing apparatus according to a twenty-second example embodiment.

FIG. 31 is a functional block diagram of the information processing apparatus according to a twenty-third example embodiment.

FIG. 32 is a functional block diagram of the information processing apparatus according to a twenty-fourth example embodiment.

FIG. 33 is a diagram showing an example of information stored in the biometric information DB according to a modified example embodiment.

### DESCRIPTION OF EMBODIMENTS

Exemplary example embodiments of the present invention will be described below with reference to the drawings. Throughout the drawings, the same elements or corresponding elements are labeled with the same references, and the description thereof may be omitted or simplified.

### First Example Embodiment

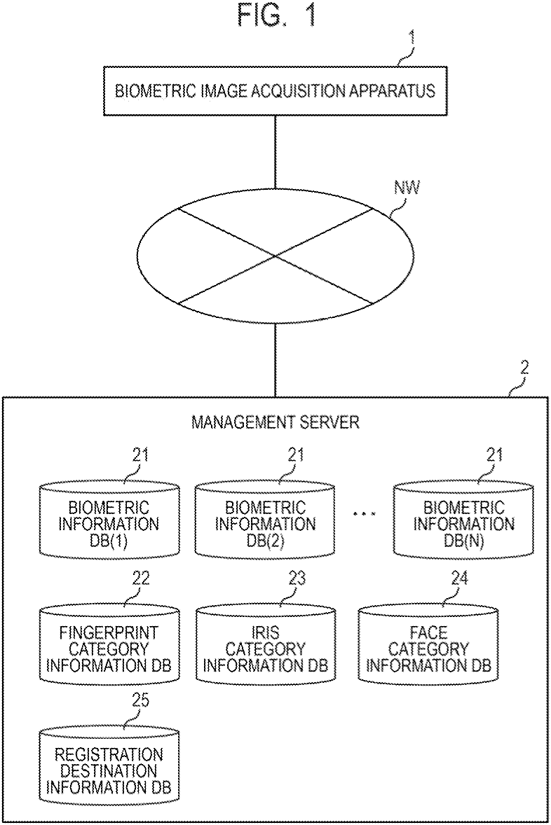

FIG. 1 is a schematic diagram showing an overall configuration of a biometric authentication system according to this example embodiment. The biometric authentication system includes a biometric image acquisition apparatus 1 and a management server 2. The biometric image acquisition apparatus 1 and the management server 2 are connected in a communicable manner via a network NW.

The biometric authentication system is a multimodal biometric authentication system that determines whether or not a subject and the registrant are the same person by capturing the plurality of different biometric images of the subject and matching the plurality of biometric images with registered biometric images of the registrant pre-registered in the database for each type of biometric image.

The biometric image acquisition apparatus 1 is an apparatus that captures a biometric image of a subject and outputs the biometric image to the management server 2. The biometric image acquisition apparatus 1 may be, for example, a terminal for identification used at an immigration site, administrative agencies, entrance gates of facilities, or the like. In this case, the biometric image acquisition apparatus 1 is used to determine whether or not the subject is a person with authority to enter the country, use administrative organs, enter facilities, or the like. The biometric image acquisition apparatus 1 may be, for example, an information processing apparatus such as a smartphone or a personal computer (PC). In this case, the biometric image acquisition apparatus 1 can perform an identity confirmation by biometric authentication at the time of login, use of an application software, entering and leaving restricted areas, electronic payment, or the like. The user of the biometric image acquisition apparatus 1 may be the subject or an administrator who performs the identity confirmation of the subject.

The management server 2 is an information processing apparatus that performs each of a registration process and a matching process, based on the plurality of biometric images of the subject acquired from the biometric image acquisition apparatus 1. First, the function of the management server 2 as a registration apparatus is briefly described. The management server 2 acquires a plurality of biometric information of different types from each other from the subject to be registered. Next, the management server 2 specifies, based on features of each of the plurality of biometric information, a category to which each of the plurality of the biometric information belongs, among a plurality of categories set for each of the types. Then, the management server 2 registers the plurality of biometric information and the categories to which of the biometric information belong respectively in a storage area (biometric information DB 21 to be described later) in association with each subject to be registered. Thus, the biometric information (hereafter referred to as registered biometric information) of the registrant is classified into a plurality of pre-set categories for each type of biometric information and stored in the storage area in a state associated with each registrant.

Next, the function of the management server 2 as a matching device will be briefly described. The management server 2 acquires a plurality of biometric information of different types from each other from the subject to be matched. Next, the management server 2 specifies, based on features of each of the plurality of biometric information, a category to which each of the plurality of the biometric information belongs, among a plurality of categories set for each of the types. Then, the management server 2 determines a matching destination based on the specified category, and performs the matching process between the plurality of biometric information of the subject to be matched and the plurality of registered biometric information of the registrant for each type. The management server 2 can reduce the number of the matching destinations based on the categories specified by the same method as when the registered biometric information is registered and execute the matching process. Details of the registration and matching process will be described later.

The network NW can be a variety of networks, such as a local area network (LAN) or a wide area network (WAN). The network NW may be, for example, the Internet, or a closed network of institutions utilizing the results of biometric matching.

In FIG. 1, the biometric system consists of a biometric image acquisition apparatus 1 and a management server 2, but the configuration of the biometric system is not limited to thereto. For example, the biometric system may be a single device that combines the functions of the biometric image acquisition apparatus 1 and the management server 2, or a system that includes three or more devices.

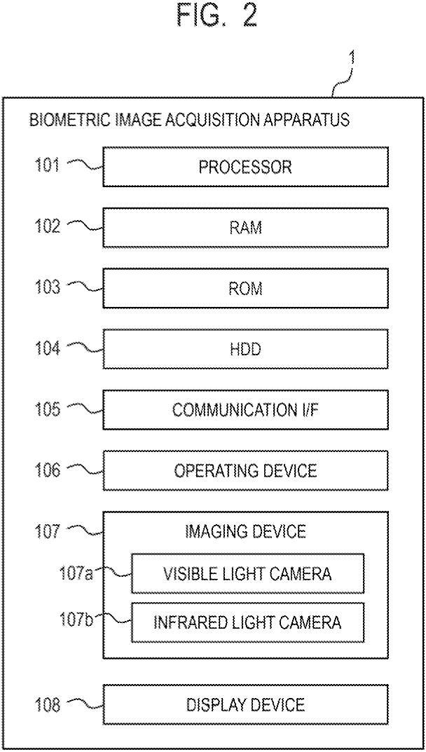

FIG. 2 is a block diagram showing an example of a hardware configuration of the biometric image acquisition apparatus 1. The biometric image acquisition apparatus 1 includes a processor 101, a random access memory (RAM) 102, a read only memory (ROM) 103, and a hard disk drive (HDD) 104. The biometric image acquisition apparatus 1 also includes a communication I/F (Interface) 105, an operating device 106, an imaging device 107, and a display device 108. Each part of the biometric image acquisition apparatus 1 is connected to each other via buses, wiring, driving devices, or the like (not shown).

In FIG. 2, each component of the biometric image acquisition apparatus 1 is shown as an integrated apparatus, but some of these functions may be provided by an external device. For example, the operating device 106, the imaging device 107, and the display device 108 may be external devices separate from the parts that constitute the functions of the computer, including the processor 101, or the like.

The processor 101 performs predetermined operations according to programs stored in the ROM 103, HDD 104, or the like, and also has a function to control each part of the biometric image acquisition apparatus 1. As the processor 101, one of a central processing unit (CPU), a graphics processing unit (GPU), a field programmable gate array (FPGA), a digital signal processor (DSP), or an application specific integrated circuit (ASIC) may be used, or the plurality of processors may be used in parallel. The RAM 102 is composed of a volatile storage medium and provides a temporary memory area necessary for the operation of the processor 101. The ROM 103 is composed of a nonvolatile storage medium and stores necessary information such as programs used for the operation of the biometric image acquisition apparatus 1. The HDD 104 is composed of a nonvolatile storage medium and is a storage device for storing a database, storing an operating program of the biometric image acquisition apparatus 1, or the like.

The communication I/F 105 is a communication interface based on standards such as Ethernet (registered trademark) and Wi-Fi (registered trademark). The communication I/F 105 is a module for communicating with other devices such as the management server 2.

The operating device 106 is a user interface device such as a button, a touch panel, or the like, for the subject, the administrator, or the like, to operate the biometric image acquisition apparatus 1.

The imaging device 107 is a digital camera with a complementary metal-oxide-semiconductor (CMOS) image sensor, a charge coupled device (CCD) image sensor or the like as light receiving elements. The imaging device 107 acquires digital image data by capturing a fingerprint image, an iris image, and a face image, respectively, as biometric information of the subject. In addition, as the imaging device 107 in this example embodiment, there are a visible light camera 107a that captures an optical image by visible light and an infrared light camera 107b that captures an optical image by infrared light. One or both of the visible light camera 107a and the infrared light camera 107b are used as appropriate depending on the type of biometric image to be captured and the environment for capturing.

The display device 108 is a liquid crystal display, an organic light emitting diode (OLED) display, or the like, and is used for displaying information, a graphical user interface (GUI) for operation input, or the like. The operating device 106 and the display device 108 may be integrally formed as a touch panel.

The biometric image acquisition apparatus 1 may further include a light source device that irradiates the iris of the subject with light having a wavelength suitable for imaging with visible or infrared light. This light source device irradiates the subject with light in synchronization with the capturing by the imaging device 107.

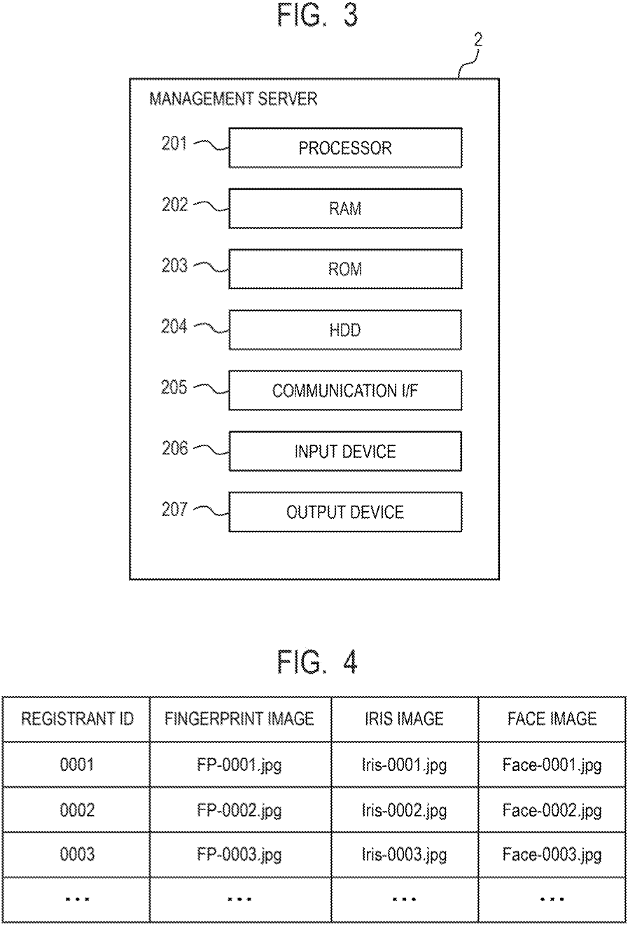

FIG. 3 is a block diagram showing an example of a hardware configuration of the management server 2. The management server 2 includes a processor 201, a RAM 202, a ROM 203, a HDD 204, a communication I/F 205, an input device 206, and an output device 207. Each part of the management server 2 is connected to each other via buses, wiring, driving devices, or the like (not shown). Since the processor 201, the RAM 202, the ROM 203, the HDD 204, and the communication I/F 205 are similar to the processor 101, RAM 102, ROM 103, HDD 104, and communication I/F 105, and their descriptions will be omitted.

The input device 206 is a keyboard, a pointing device, or the like, and is used by the administrator of the management server 2 to operate the management server 2. Examples of pointing devices include a mouse, a trackball, a touch panel, a pen tablet, or the like. The output device 207 is a display device having the same configuration as, for example, the display device 108. The input device 206 and the output device 207 may be integrally formed as a touch panel.

The hardware configurations of the biometric image acquisition apparatus 1 and the management server 2 are examples, and devices other than them may be added or a part of devices may not be provided. Also, some devices may be replaced by other devices with similar functions. Furthermore, some functions in this example embodiment may be provided by other devices via a network, or the functions in this example embodiment may be realized by being distributed among the plurality of devices. For example, HDDs 104 and 204 may be replaced by solid state drives (SSDs) using semiconductor memories. The HDDs 104 and 204 may be replaced by cloud storage. Thus, the hardware configuration of the biometric image acquisition apparatus 1 and the management server 2 can be appropriately changed.

As shown in FIG. 1, the management server 2 also includes a biometric information DB 21, a fingerprint category information DB 22, an iris category information DB 23, a face category information DB 24, and a registration destination information DB 25. These databases are only examples, and the management server 2 may additionally have other databases.

The biometric information DB 21 is a database that stores a plurality of biometric information of different types for each registrant. In this example embodiment, N pieces of biometric information DBs 21 are provided (N is a natural number of two or more). The registered biometric information of all registrants is stored in each of databases corresponding to combinations of the categories to which each of the plurality of biometric information of different types belongs among the N pieces of biometric information DBs 21. In this example embodiment, the “category” indicates a category that classifies each of the features extracted from biometric information or each of the attributes of persons estimated based on the features. The categories shall be predefined for each type of biometric information.

FIG. 4 is a diagram showing an example of information stored in the biometric information DB 21. In FIG. 4, the biometric information DB 21 includes a registrant ID, a fingerprint image, an iris image, and a face image as data items. That is, the biometric information DB 21 stores combinations of three types of biometric information in association with each registrant. Fingerprint images (FP-0001.jpg/FP-0002.jpg/FP-0003.jpg) of each registrant belong to a common fingerprint category. This is also the case for iris image and face image, and the iris image and face image of each registrant belong to a common iris category and face category, respectively. In the example of FIG. 4, the registered biometric information of three registrants with registrant IDs of “0001”, “0002”, and “0003” is registered in the same biometric information DB 21 on the condition that the registered biometric information belong to a common category for all three types.

The fingerprint category information DB 22 is a database that defines fingerprint categories for classifying features extracted from fingerprint images. In this example embodiment, the pattern of ridges is extracted as a feature of the fingerprint image.

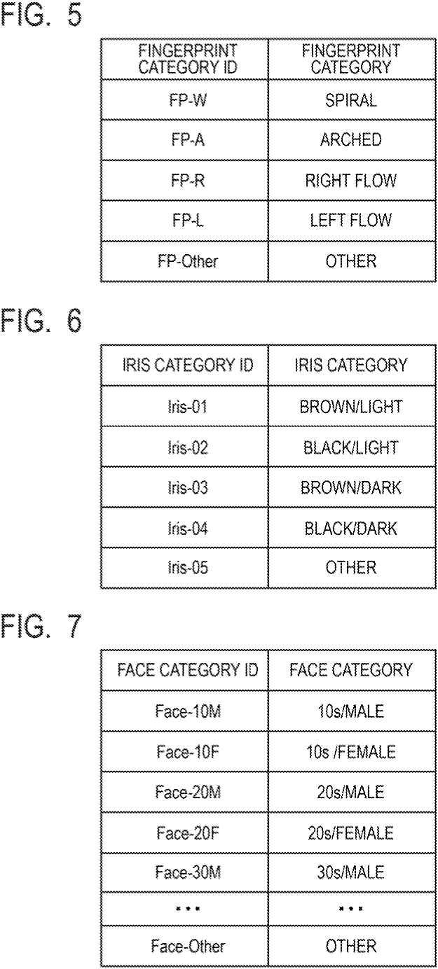

FIG. 5 is a diagram showing an example of information stored in the fingerprint category information DB 22. Here, the fingerprint category information DB 22 includes a fingerprint category ID and a fingerprint category as data items. Five fingerprint categories are exemplified: “Spiral”, “arched”, “right flow”, “left flow”, and “Other”. Note that the fingerprint category “Other” indicates that the feature extracted from the fingerprint image does not match any of the categories of “Spiral”, “arched”, “right flow”, or “left flow”.

The iris category information DB 23 is a database that defines iris categories for classifying features extracted from iris images. In this example embodiment, the color and luminance of the iris are extracted as feature of the iris image.

FIG. 6 is a diagram showing an example of information stored in the iris category information DB 23. Here, the iris category information DB 23 includes the iris category ID and the iris category in the data items. Five iris categories are exemplified: “Brown/Light”, “Black/Light”, “Brown/Dark”, “Black/Dark”, and “Other”. The iris category of “Other” indicates that the feature extracted from the iris image dose not match any of the following categories: “Brown/Light”, “Black/Light”, “Brown/Dark”, or “Black/Dark”.

The face category information DB 24 is a database that defines face categories for classifying attributes of persons estimated from face images. In this example embodiment, age and gender are assumed as attributes of the person. These attributes can be estimated by extracting the appearance features (For example, the presence or absence of wrinkles or spots on the face, the distance between parts, or the like.) from the face image based on well-known algorithms.

FIG. 7 is a diagram showing an example of information stored in the face category information DB 24. Here, the face category information DB 24 includes a face category ID and a face category in the data items. Examples of face categories include “10s/Male”, “10s/Female”, “20s/Male”, “20s/Female”, “30s/Male”, and “Other”. That is, face categories are defined for each combination of a person’s age range and gender. Note that the face category “Other” indicates that one or both of a person’s age and gender could not be estimated from the face image.

The registration destination information DB 25 is a database that defines the correspondence between the combination information of different types of biometric information and the biometric information DB 21 to be the registration destination.

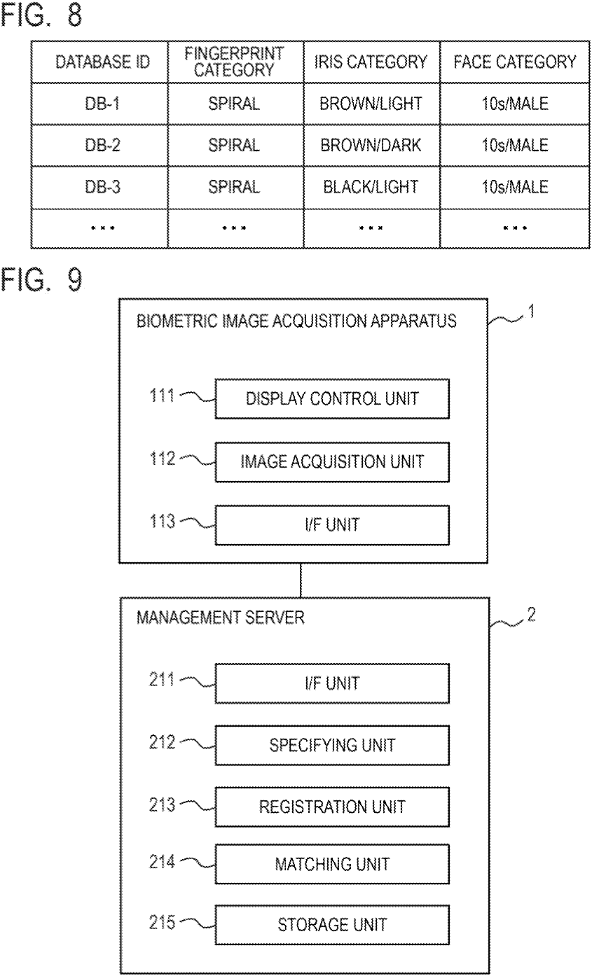

FIG. 8 is a diagram showing an example of information stored in the registration destination information DB 25. Here, the registration destination information DB 25 includes a database ID, a fingerprint category, an iris category, and a face category as data items. The registration destination information DB 25 may further include the ID of each category in the data item. For example, the biometric information DB 21 with the database ID of “DB-1” is a database that stores only information of registrants for whom all three types of biometric information are acquired: a fingerprint image with the fingerprint category of “Spiral”, an iris image with the iris category of “Brown/Light”, and a face image with a face category of “10s/Male”.

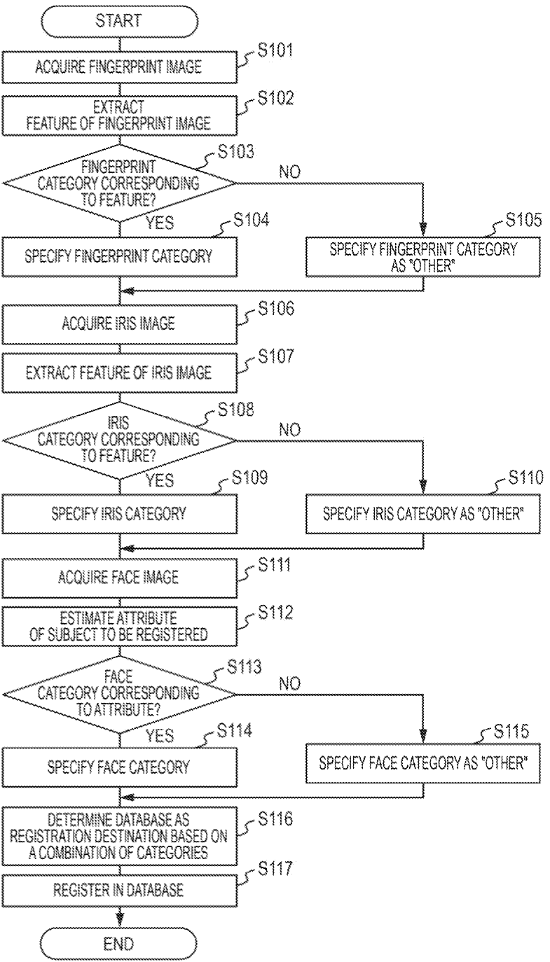

FIG. 9 is a functional block diagram of the biometric authentication system according to this example embodiment. The biometric image acquisition apparatus 1 includes a display control unit 111, an image acquisition unit 112 and an I/F unit 113. The management server 2 includes an I/F unit 211, a specifying unit 212, a registration unit 213, a matching unit 214, and a storage unit 215.

The processor 101 performs a predetermined arithmetic processing by loading programs stored in the ROM 103, the HDD 104, or the like, into the RAM 102 and performing them. Based on the program, the processor 101 controls each part of the biometric image acquisition apparatus 1 such as the communication I/F 105, the operating device 106, the imaging device 107, and the display device 108. Thus, the processor 101 realizes the functions of the display control unit 111, the image acquisition unit 112 and the I/F unit 113.

The processor 201 performs a predetermined arithmetic processing by loading programs stored in the ROM 203, HDD 204, or the like, into the RAM 202 and performing them. Based on the program, the processor 201 controls each part of the management server 2 such as the communication I/F 205, the input device 206, and the output device 207. Thus, the processor 201 realizes the functions of the I/F unit 211, the specifying unit 212, the registration unit 213, the matching unit 214 and the storage unit 215. Details of the specific processing performed by each functional block will be described later.

Some or all of the functions of the functional blocks described in the biometric image acquisition apparatus 1 and the management server 2 in FIG. 9 may be provided in devices outside the biometric image acquisition apparatus 1 and the management server 2. That is, each of the functions described above may be realized by cooperation between the biometric image acquisition apparatus 1, the management server 2, and other devices. In addition, the biometric image acquisition apparatus 1 and the management server 2 may be an integrated device, and some of the functions of the functional blocks described in either the biometric image acquisition apparatus 1 or the management server 2 may be realized by the other device. That is, the device in which each functional block in FIG. 9 is provided is not limited to that shown in FIG. 9.

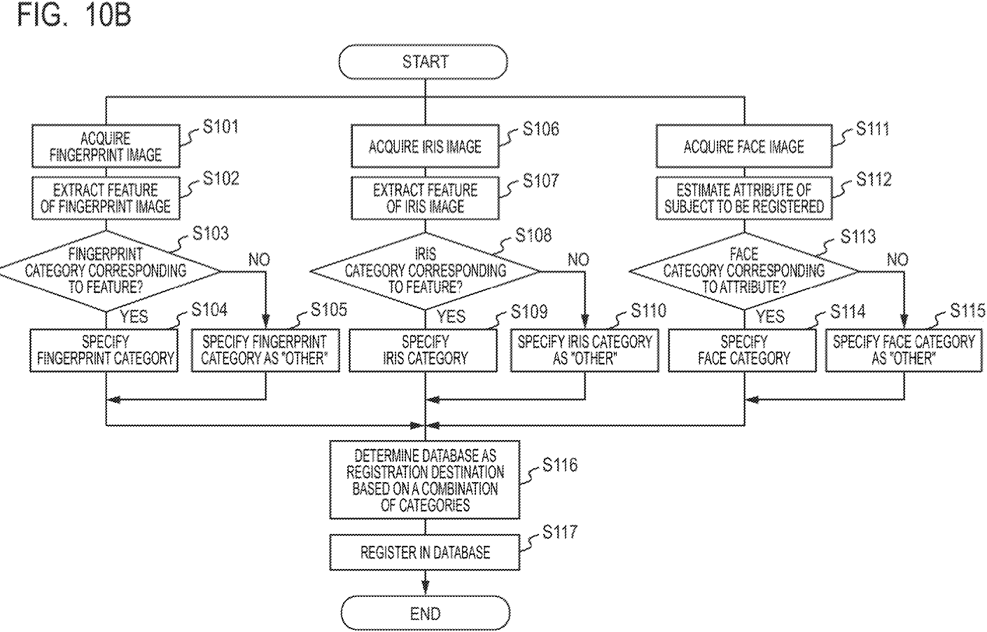

FIG. 10A is a flow chart showing an outline of a registration process performed by the biometric authentication system according to this example embodiment. The process in FIG. 10A starts, for example, when the subject to be registered or the administrator operates the biometric image acquisition apparatus 1 in order to register the biometric information of the subject to be registered in the database.

In step S101, the biometric image acquisition apparatus 1 (image acquisition unit 112) acquires the fingerprint image of the subject to be registered and transmits the fingerprint image to the management server 2.

In step S102, the management server 2 (specifying unit 212) performs image analysis of the fingerprint image received from the biometric image acquisition apparatus 1 and extracts a feature of the fingerprint image.

In step S103, the management server 2 (specifying unit 212) determines whether or not there is a fingerprint category corresponding to the extracted feature. Here, when the management server 2 determines that there is a fingerprint category corresponding to the feature (step S103: YES), the management server 2 (specifying unit 212) specifies the fingerprint category (step S104). Then, the process proceeds to step S106.

On the other hand, when the management server 2 (specifying unit 212) determines that there is no fingerprint category corresponding to the feature (step S103: NO), the management server 2 specifies the fingerprint category as “Other” (step S105). That is, when the feature extracted from the fingerprint image of the subject to be registered cannot be classified into the predetermined fingerprint category, the feature is classified into the fingerprint category “Other” which is the classification destination for exceptional features. Then, the process proceeds to step S106.

In step S106, the biometric image acquisition apparatus 1 (image acquisition unit 112) acquires an iris image of the subject to be registered and transmits the iris image to the management server 2.

In step S107, the management server 2 (specifying unit 212) performs image analysis on the iris image received from the biometric image acquisition apparatus 1 and extracts a feature of the iris image.

In step S108, the management server 2 (specifying unit 212) determines whether there is an iris category corresponding to the extracted feature. When the management server 2 determines that there is an iris category corresponding to the feature (step S108: YES), the management server 2 (specifying unit 212) specifies the iris category (step S109). Then, the process proceeds to step S111.

On the other hand, when the management server 2 (specifying unit 212) determines that there is no iris category corresponding to the feature (step S108: NO), the management server 2 specifies the iris category as “Other” (step S110). That is, when the feature extracted from the iris image of the subject to be registered cannot be classified into a predetermined iris category, the feature is classified into the iris category “Other” which is the classification destination for exceptional features. Then, the process proceeds to step S111.

In step S111, the biometric image acquisition apparatus 1 (image acquisition unit 112) acquires the face image of the subject to be registered and transmits the face image to the management server 2.

In step S112, the management server 2 (specifying unit 212) performs image analysis on the face image received from the biometric image acquisition apparatus 1 and extracts a feature of the face image. Then, the management server 2 (specifying unit 212) estimates attribute (age and gender) of the subject to be registered based on the feature.

In step S113, the management server 2 (specifying unit 212) determines whether or not there is a face category corresponding to the estimated attribute. When the management server 2 determines that there is a face category corresponding to the attribute (step S113: YES), the management server 2 specifies the face category (step S114). Then, the process proceeds to step S116.

On the other hand, when the management server 2 (specifying unit 212) determines that there is no face category corresponding to the attribute (step S113: NO), the management server 2 specifies the face category as “Other” (step S115). That is, because the attribute acquired from the face image of the subject to be registered cannot be classified into the predetermined face category, the attribute is classified into the face category “Other” which is the classification destination for exceptional features. Then, the process proceeds to step S116.

In step S116, the management server 2 (registration unit 213) determines a database as the registration destination based on the combination of categories to which each of the fingerprint image, the iris image, and the face image belong. Specifically, the management server 2 refers to the registration destination information DB 25 based on the combination and selects the database as registration destination from the N pieces of biometric information DBs 21.

In step S117, the management server 2 (registration unit 213) registers the fingerprint image, the iris image, and the face image of the subject to be registered in the database that is the registration destination determined in step S116, and the process ends.

In FIG. 10A, the process for specifying the category of biometric information is performed in series in the order of the fingerprint, the iris, and the face. However, the order of the process is not limited to thereto. The process may be performed in the order of, for example, the face, the fingerprint, and the iris. The flowchart in FIG. 10A may also be transformed into a flowchart of a parallel process as in FIG. 10B. In FIG. 10B, the step numbers in common with those in FIG. 10A are the same process, so a detailed description of each step is omitted.

In FIG. 10B, the specifying process of the fingerprint category (steps S101 to S105), the specifying process of the iris category (steps S 106 to S110), and the specifying process of the face category (steps S111 to S115) are performed in parallel.

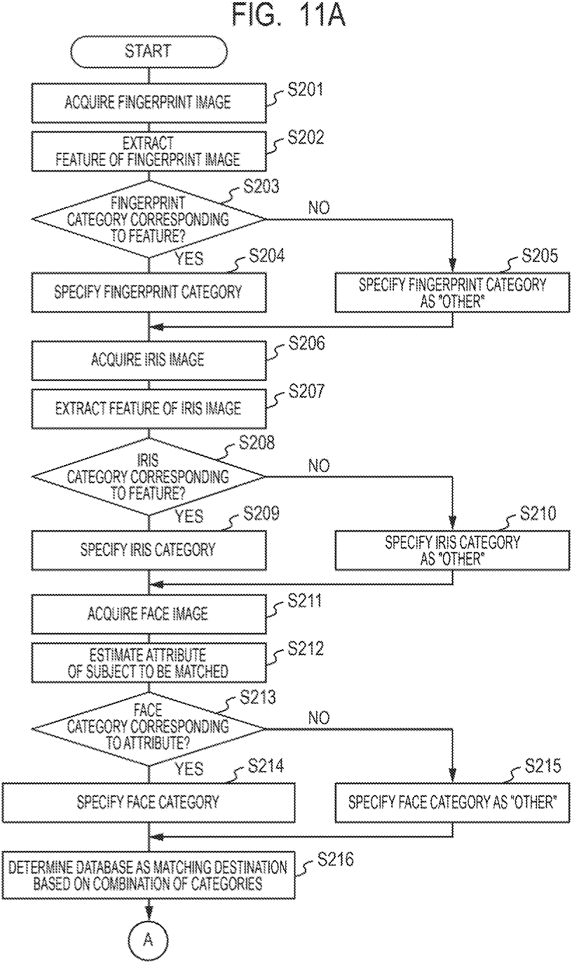

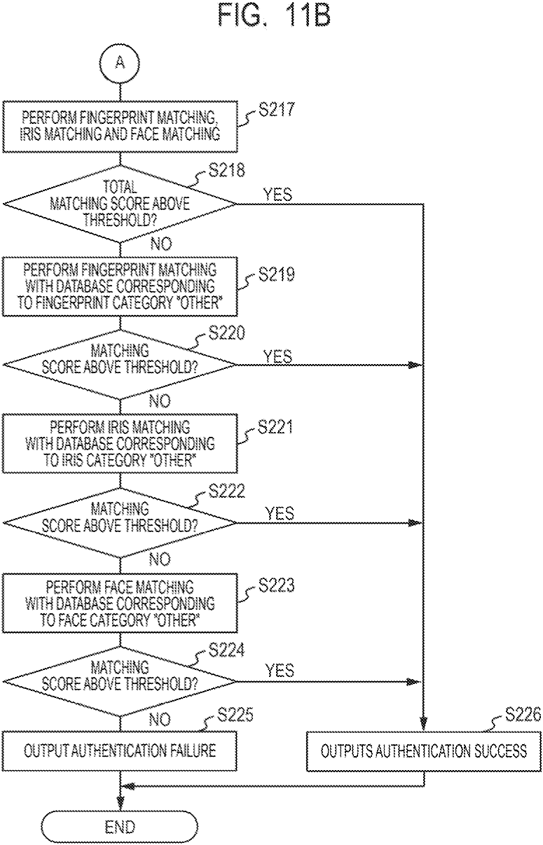

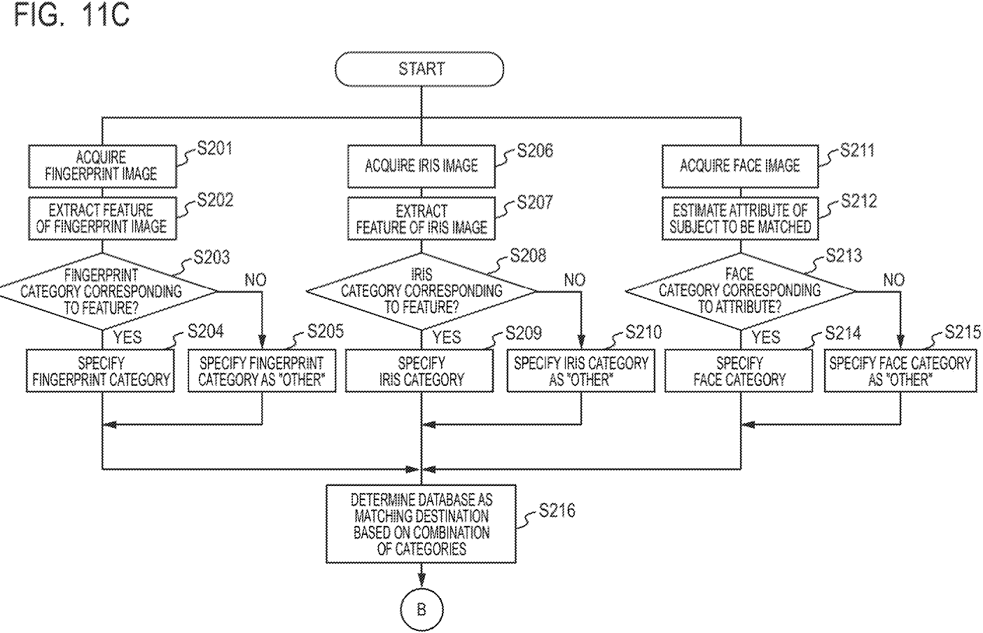

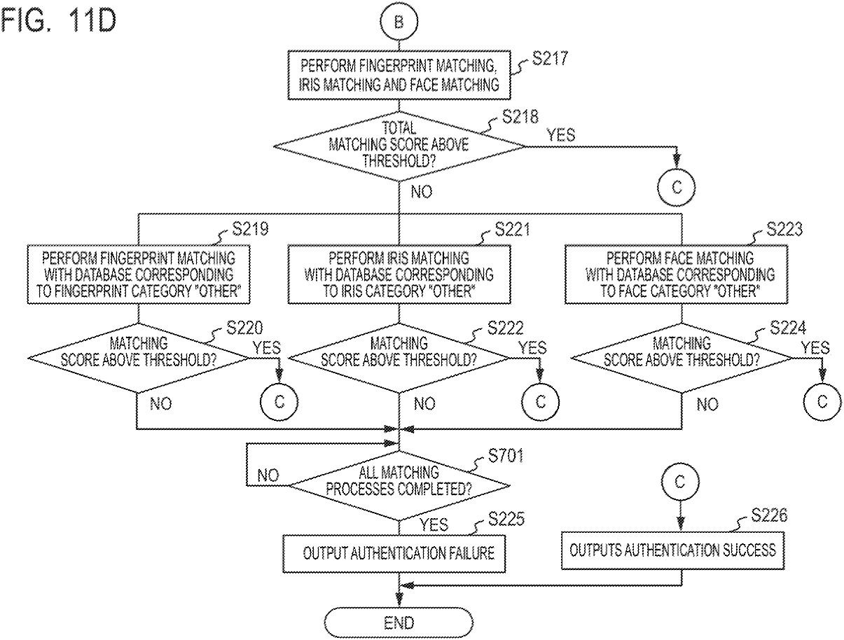

FIGS. 11A and 11B are flowcharts showing an outline of a matching process performed by the biometric authentication system according to this example embodiment. The process of FIG. 11A and FIG. 11B is started, for example, when the subject to be matched or the administrator operates the biometric image acquisition apparatus 1 in order to match the subject to be matched with the registrant.

In step S201, the biometric image acquisition apparatus 1 (image acquisition unit 112) acquires a fingerprint image of the subject to be matched and transmits the fingerprint image to the management server 2.

In step S202, the management server 2 (specifying unit 212) performs image analysis of the fingerprint image acquired from the biometric image acquisition apparatus 1 and extracts a feature of the fingerprint image.

In step S203, the management server 2 (specifying unit 212) determines whether or not there is a fingerprint category corresponding to the extracted feature. Here, when the management server 2 determines that there is a fingerprint category corresponding to the feature (step S203: YES), the management server 2 (specifying unit 212) specifies the fingerprint category (step S204). Then, the process proceeds to step S206.

On the other hand, when the management server 2 (specifying unit 212) determines that there is no fingerprint category corresponding to the feature (step S203: NO), the management server 2 specifies the fingerprint category as “Other” (step S205). That is, when the feature extracted from the fingerprint image of the subject to be matched cannot be classified into the predetermined fingerprint category, the feature is classified into the fingerprint category “Other” which is the classification destination for the exceptional features. Then, the process proceeds to step S206.

In step S206, the biometric image acquisition apparatus 1 (image acquisition unit 112) acquires an iris image of the subject to be matched and transmits the iris image to the management server 2.

In step S207, the management server 2 (specifying unit 212) performs image analysis on the iris image received from the biometric image acquisition apparatus 1 and extracts a feature of the iris image.

In step S208, the management server 2 (specifying unit 212) determines whether there is an iris category corresponding to the extracted feature. When it is determined that there is an iris category corresponding to the feature (step S208: YES), the management server 2 (specifying unit 212) specifies the iris category (step S209). Then, the process proceeds to step S211.

On the other hand, when the management server 2 (specifying unit 212) determines that there is no iris category corresponding to the feature (step S208: NO), the management server 2 specifies the iris category as “Other” (step S210). That is, when the feature extracted from the iris image of the subject to be matched cannot be classified into a predetermined iris category, the feature is classified into the iris category “other” which is the classification destination for exceptional features. Then, the process proceeds to step S211.

In step S211, the biometric image acquisition apparatus 1 (image acquisition unit 112) acquires a face image of the subject to be matched and transmits the face image to the management server 2.

In step S212, the management server 2 (specifying unit 212) analyzes the face image received from the biometric image acquisition apparatus 1 and extracts a feature of the face image. Then, the management server 2 (specifying unit 212) estimates the attribute (age and gender) of the subject to be matched based on the feature.

In step S213, the management server 2 (specifying unit 212) determines whether there is a face category corresponding to the estimated attribute. Here, when the management server 2 determines that there is a face category corresponding to the attribute (step S213: YES), the management server 2 (specifying unit 212) specifies the face category (step S214). Then, the process proceeds to step S216.

On the other hand, when the management server 2 (specifying unit 212) determines that there is no face category corresponding to the attribute (step S213: NO), the management server 2 specifies the face category as “Other” (step S215). That is, because the attribute acquired from the face image of the subject to be matched cannot be classified into a predetermined face category, the attribute is classified into the face category “Other” which is the classification destination for exceptional features. Then, the process proceeds to step S216.

In step S216, the management server 2 (matching unit 214) determines a database of a matching destination based on the combination of categories to which each of the fingerprint image, the iris image, and the face image belong. Specifically, the management server 2 refers to the registration destination information DB 25 based on the combination of categories, and selects one matching destination database from the N pieces of biometric information DBs 21.

In step S217, the management server 2 (matching unit 214) performs a fingerprint matching process, an iris matching process, and a face matching process regarding the three types of biometric images acquired from the subject to be matched, respectively. Each of matching processes may be performed in parallel or sequentially. In the matching process, for example, the matching unit 214 calculates the feature amount from the biometric information of the subject to be matched. Next, based on the degree of concordance between a feature amount of the biometric information of the subject to be matched and a feature amount calculated in advance for the registered biometric information, a matching score may be calculated. Then, when the matching score is equal to or greater than the threshold, it may be determined that the subject to be matched and the registrant are the same person.

In this example embodiment, it is preferable that the algorithm for extracting the feature of the face image among the three types of biometric images is different from the algorithm for calculating a feature amount in the matching process. Instead of specifying the category to which the face image belongs based on the feature amount calculated from the face image, the algorithm estimates an attribute of a person from the feature of the face image extracted by directly analyzing the face image. This is in view of the fact that well-known algorithms that can estimate the age and gender of a person are different from algorithms for calculating the feature amount in the matching process.

The features of the biometric information other than the face image may also be extracted using an algorithm different from the algorithm for calculating the feature amount in the matching process. If each of biometric information can be classified into an appropriate category, the feature of each of biometric information may be extracted by using the same algorithm as the algorithm for calculating the feature amount in the matching process.

In step S218, the management server 2 (matching unit 214) determines whether or not there is a registrant whose total matching score is equal to or greater than the threshold. Here, when the management server 2 (matching unit 214) determines that there is a registrant whose total matching score is equal to or greater than a threshold (step S218: YES), the process proceeds to step S226.

On the other hand, when the management server 2 (matching unit 214) determines that there is no registrant whose total matching score is equal to or greater than the threshold (step S218: NO), the process proceeds to step S219.

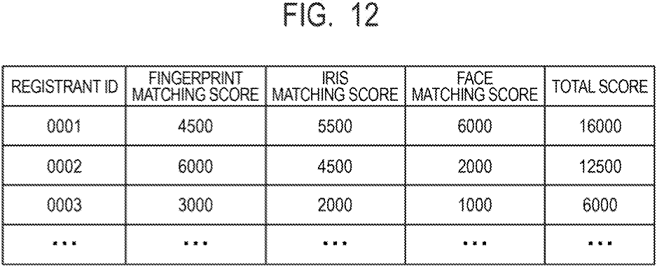

FIG. 12 is a diagram showing an example of a matching result in the biometric authentication system according to this example embodiment. In FIG. 12, a fingerprint matching score, an iris matching score, a face matching score, and a total score are shown for each registrant ID of the registrant who has been matched with the biometric image of the subject to be matched. For example, when the threshold for the matching score is 15000, the registrant whose registrant ID is “0001” may be authenticated as the same person as the subject to be matched. In stead of the threshold the total score, a person may be authenticated as the same person by comparison with the threshold for each type of biometric information. When the matching scores above the threshold are acquired for all types, the person may be authenticated as the same person. In addition, the matching score may be weighted for each of the types to perform a determination process.

In step S219, the management server 2 (matching unit 214) performs a fingerprint matching process on the fingerprint image of the subject to be matched with the biometric information DB 21 whose fingerprint category is “Other” as the matching destination.

In step S220, the management server 2 (matching unit 214) determines whether or not there is a registrant whose matching score in the fingerprint matching process is equal to or greater than the threshold. Here, when the management server 2 (matching unit 214) determines that there is a registrant whose matching score in the fingerprint matching is equal to or greater than the threshold (step S220: YES), the process proceeds to step S226.

On the other hand, when the management server 2 (matching unit 214) determines that there is no registrant whose matching score in the fingerprint matching process is equal to or greater than the threshold (step S220: NO), the process proceeds to step S221.

In step S221, the management server 2 (matching unit 214) performs an iris matching process on the iris image of the subject to be matched using the biometric information DB 21 whose iris category is “Other” as the matching destination.

In step S222, the management server 2 (matching unit 214) determines whether there is a registrant whose matching score in the iris matching process is equal to or greater than a threshold. Here, when the management server 2 (matching unit 214) determines that there is a registrant whose matching score in the iris matching process is equal to or greater than the threshold (step S222: YES), the process proceeds to step S226.

On the other hand, when the management server 2 (matching unit 214) determines that there is no registrant whose matching score in the iris matching process is equal to or greater than the threshold (step S222: NO), the process proceeds to step S223.

In step S223, the management server 2 (matching unit 214) performs a face matching process on the face image of the subject to be matched using the biometric information DB 21 whose face category is “Other” as the matching destination.

In step S224, the management server 2 (matching unit 214) determines whether there is a registrant whose matching score in the face matching process is equal to or greater than a threshold. Here, when the management server 2 (matching unit 214) determines that there is a registrant whose matching score in the face matching process is equal to or greater than the threshold (step S224: YES), the process proceeds to step S226.

On the other hand, when the management server 2 (matching unit 214) determines that there is no registrant whose matching score in the face matching process is equal to or greater than the threshold (step S224: NO), the process proceeds to step S225.

In step S225, since there is no registrant matching the subject to be matched, the management server 2 (matching unit 214) outputs information of the authentication failure, and the process ends.

In step S226, the management server 2 (matching unit 214) assumes that the subject to be matched and the registrant are the same person, outputs the information of the authentication success, and the process ends.

In the flowchart shown in FIG. 11B, when the matching process with the biometric information DB 21 as the matching destination corresponding to the category combination fails to authenticate the subject to be matched (step S218: NO), the fingerprint matching process, the iris matching process, and the face matching process are sequentially performed with the biometric information DB 21 corresponding to the category “Other”. This takes into account the case where the matching accuracy is high in the order of the fingerprint matching process, the iris matching process, and the face matching process. This makes it possible to efficiently execute the matching process of the second step (step S219, step S221, step S223) even if the subject to be matched could not be authenticated in the matching process of the first step (step S217).

In FIG. 11A, the process for specifying the category of biometric information is performed in series in the order of the fingerprint, the iris, and the face. However, the order of the process is not limited to thereto. The process may be performed in the order of, for example, the face, the fingerprint, and the iris. Similarly, in FIG. 11B, when the sum of the matching scores of the three types of matching process is less than a predetermined threshold (step S218: NO), the matching process and the determination process of the matching score using the biometric information DB 11 corresponding to the category “Other” as the matching destination are performed in series in the order of the fingerprint, the iris, and the face. However, the order of the process is not limited to thereto. The process may be performed in the order of, for example, the face, the fingerprint, and the iris.

The flowcharts in FIGS. 11A and 11B may be transformed into flowcharts of parallel processes as in FIGS. 11C and 11D, respectively. In FIG. 11C and FIG. 11D, the step numbers common to FIG. 11A and FIG. 11B are the same process, so a detailed description of each step is omitted.

In FIG. 11C, the specifying process of the fingerprint category (steps S201 to S205), the specifying process of the iris category (steps S206 to S210), and the specifying process of the face category (steps S211 to S215) are performed in parallel.

In FIG. 11D, when the sum of the matching scores of the three types of matching process is less than a predetermined threshold (step S218: NO), the fingerprint matching process and the determination process of the matching score (step S219 to step S220), the iris matching process and the determination process of the matching score (step S221 to step S222), and the face matching process and the determination process of matching score (step S223 to step S224) are performed in parallel.

Then, when all matching process performed in parallel is completed with “matching score: less than threshold” (step S701: YES), an authentication failure is output (step S225), and the process ends. On the other hand, when the matching score is equal to or greater than the threshold in any one of all types of matching process performed in parallel (step S220: YES/step S222: YES/step S224: YES), the authentication success is output (step S226), and the process ends.

In addition, the flowcharts of FIGS. 11A-11D are free to vary combinations, for example, combinations of FIGS. 11A and 11D and combinations of FIGS. 11C and 11B. That is, at least one of the specifying process of categories of biometric information and the process related to matching (matching process/determination process of the matching score) may be parallel.

As described above, in this example embodiment, the different types of biometric information (fingerprint image, iris image, face image) acquired from the subject to be registered are registered in the biometric information DB 21 corresponding to the combination pattern of the categories after specifying categories to which each of images belong respectively among the categories set for each type of biometric information. Similarly, regarding different types of biometric information (fingerprint image, iris image, face image) acquired from the subject to be matched, the categories are specified by type using the same methods as the registration. It is possible to reduce the number of the databases as the matching destination at the time of the matching process based on the combination pattern of the categories to which the biometric information of the subject to be matched belongs, thus greatly improving the matching speed in one-to-N matching.

In addition, the features extracted from the face image of the subject are extracted using an algorithm different from the algorithm for calculating the feature amount in the matching process of the face image. And the categories of face images correspond to the features and attributes of appearance that can be easily specified by the administrator, or the like with the naked eye. This makes it easy for administrator to know whether or not face images are properly sorted based on their attributes and registered in the database.

In addition, biometric information DBs 21 divided into N pieces are provided to correspond to combinations of categories. So even if the number of registrants increases significantly, registrants are distributed across the plurality of databases. This has the effect of suppressing database bloat and suppressing the slowing down the matching speed in one-to-N matching.

In addition, among the N pieces of biometric information DBs 21 in this example embodiment, a database corresponding to an exceptional category (“Other”) is included in consideration of cases where the feature of biometric information or the attribute of a person estimated from the feature do not match a predetermined category. Therefore, even if the desired features could not be extracted from the biometric information of the subject to be matched, setting the category to “Other” can efficiently reduce the number of the matching destinations.

### Second Example Embodiment

The second example embodiment will be described below. Since this example embodiment is a variation of the first example embodiment, the same elements as the first example embodiment may be omitted or simplified.

FIG. 13 is a diagram showing an example of information stored in the face category information DB 24 according to this example embodiment. The face category information DB 24 shown in FIG. 13 differs from FIG. 7 in that the face category information DB 24 includes two face subcategory IDs as data items in addition to the face category ID. The face subcategory is information for subdividing the face category. For example, the face category with the face category ID of “Face-10M” is “10s/Male”. This face category is associated with two face subcategories (“Face-10M-L”/“Face-10M-H”). The face subcategory (“Face-10M-L”) corresponds to the attributes of “males between ten and fourteen years old”. Similarly, the face subcategory (“Face-10M-H”) corresponds to the attributes of “males between fifteen and nineteen years old”.

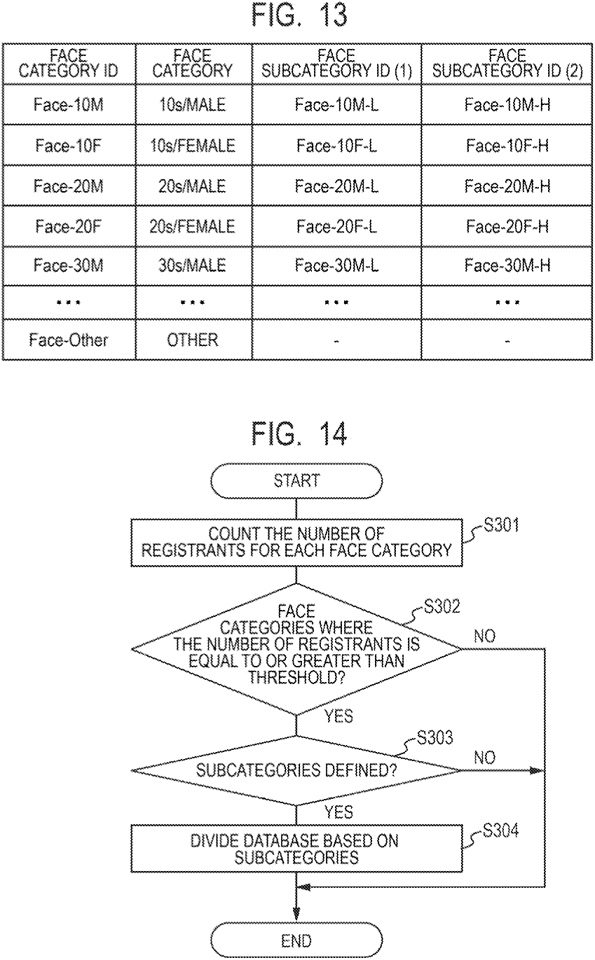

FIG. 14 is a flow chart showing an outline of an update process performed by the biometric authentication system according to this example embodiment. This process may be started automatically at a predetermined cycle, for example, or upon request from the administrator. In the following, the subdivision of the face category is described as an example, but this also applies to the fingerprint category and the iris category.

In step S301, the management server 2 (registration unit 213) counts the number of registrants for each face category for each of the N pieces of biometric information DBs 21.

In step S302, the management server 2 (registration unit 213) determines whether there is a face category whose number of registrants is equal to or greater than a predetermined threshold. When the management server 2 (registration unit 213) determines that there is a face category whose number of registrants is equal to or greater than the predetermined threshold (step S302: YES), the process proceeds to step S303. On the other hand, when the management server 2 (registration unit 213) determines that there is no face category whose number of registrants is equal to or greater than the predetermined threshold (step S302: NO), the process ends.

In step S303, the management server 2 (registration unit 213) refers to the face category information DB 24 and determines whether there is a subcategory in the face category whose number of registrants is equal to or greater than the threshold. When the management server 2 (registration unit 213) determines that there is a subcategory in the face category (step S303: YES), the process proceeds to step S304. On the other hand, when the management server 2 (registration unit 213) determines that there is no subcategory in the face category (step S303: NO), the process ends.

In step S304, the management server 2 (registration unit 213) performs update processing to divide the database based on the face subcategories for the biometric information DB 21 corresponding to the face category concerned, and the process ends.

As described above, in this example embodiment, when there is a category whose number of registrants is equal to or greater than the predetermined threshold, a process for subdividing the database is automatically performed based on the subcategory. Thus, in addition to the same effect as that of the first example embodiment, it also has the effect of preventing the enlargement of the database from slowing down the matching speed.

### Third Example Embodiment

The third example embodiment will be described below. Since this example embodiment is a variation of the first example embodiment, the same elements as the first example embodiment may be omitted or simplified.

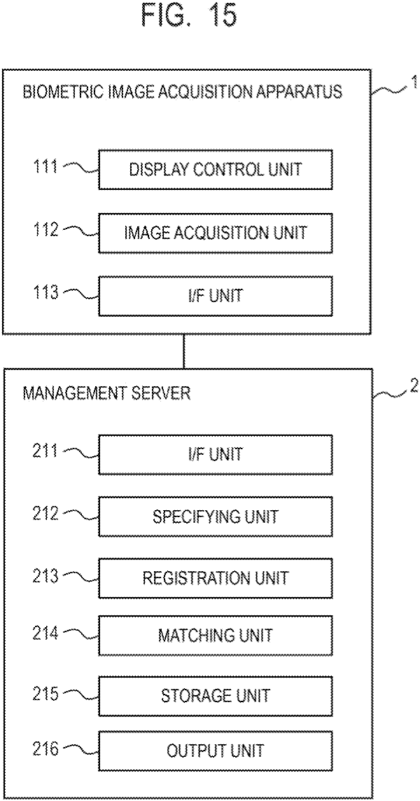

FIG. 15 is a functional block diagram of the biometric authentication system according to this example embodiment. The management server 2 in this example embodiment further includes an output unit 216 in addition to the configuration of the first example embodiment. The processor 201 functions as an output unit 216 by loading programs stored in the ROM 203, the HDD 204, or the like, into the RAM 202 and performing them.

FIG. 16 is a flow chart showing an outline of an alert information output process performed by the biometric authentication system according to this example embodiment. This process may be started automatically at a predetermined cycle, for example, or upon request from the administrator. The same process as in FIG. 16 can be performed for the fingerprint category and the iris category. In this case, the “face category” can be replaced with “fingerprint category” or “iris category,” so a detailed description is omitted.

In step S401, the management server 2 (registration unit 213) counts the number of registrants for each face category regarding each of the N pieces of biometric information DBs 21.

In step S402, the management server 2 (registration unit 213) determines whether there is a face category whose number of registrants is equal to or greater than a predetermined threshold. Here, when the management server 2 determines that there is a face category whose number of registrants is equal to or greater than the predetermined threshold (step S402: YES), the process proceeds to step S403. On the other hand, when the management server 2 determines that there is no face category whose number of registrants is equal to or greater than the predetermined threshold (step S402: NO), the process ends.

In step S403, the management server 2 (output unit 216) outputs alert information urging the administrator to subdivide the biometric information DB 21 corresponding to the face category concerned, and the process ends. The alert information includes, for example, a database ID and the category ID concerned. The output destination of the alert information is, for example, an output device 207 or a biometric image acquisition apparatus 1.

As described above, in this example embodiment, when there is a category whose number of registrants is equal to or greater than a predetermined threshold, the alert information is automatically output to the administrator. Thus, in addition to the same effect as that of the first example embodiment, this has the effect of allowing the administrator to deal with the database bloat.

### Fourth Example Embodiment

The fourth example embodiment will be described below. Since this example embodiment is a variation of the first example embodiment, the same elements as the first example embodiment may be omitted or simplified.

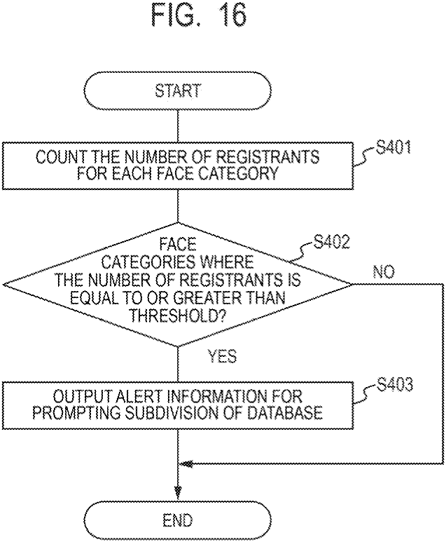

FIG. 17 is a functional block diagram of the biometric authentication system according to this example embodiment. The management server 2 in this example embodiment further includes a learning unit 217 in addition to the configuration of the first example embodiment. The processor 201 functions as the learning unit 217 by loading programs stored in the ROM 203, the HDD 204, or the like, into the RAM 202 and performing them.

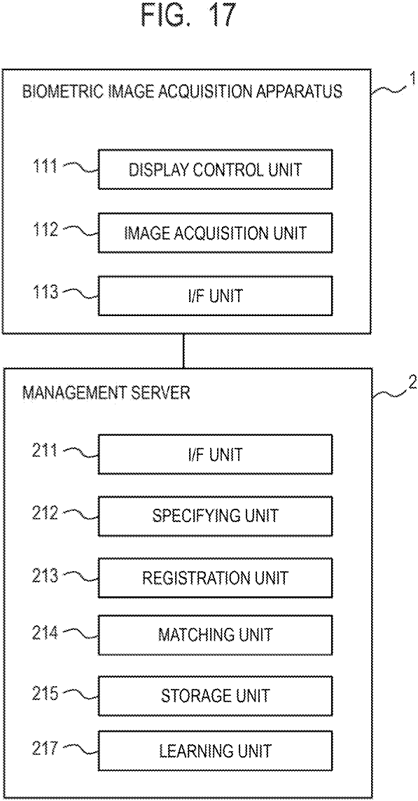

FIG. 18 is a schematic diagram showing an example of a neural net used for a learning process by the learning unit 217 according to the fourth example embodiment. The neural network shown in FIG. 18 includes an input layer with the plurality of nodes, an intermediate layer with the plurality of nodes, and an output layer with one node.

In each node of the input layer, a value indicating the age or age range of the subject estimated from the face image is input as an input value. Each node of the intermediate layers is connected to each node of the input layer. Each element of the input value input to the nodes of the intermediate layers is used for calculation in each node of the intermediate layer. Each node of the intermediate layers calculates an operation value using, for example, an input value input from nodes of the input layer, a predetermined weighting coefficient, and a predetermined bias value. Each node of the intermediate layers is connected to the output layer, and output the calculated operation value to the node of the output layer. The node of the output layer receives the operation value from some nodes of the intermediate layers.

The nodes of the output layer output a value indicating the matching range in the face matching using the arithmetic value input from each node of the intermediate layer, the weighting factor, and the bias value. Output values are compared to teacher data. For example, it is preferable to use age data estimated from the face images of the plurality of persons based on the age estimation algorithm used when specifying the face category and the actual age data of each person as teacher data in this example embodiment. When learning a neural network, for example, an error reverse propagation method is used.

Specifically, an output value acquired from the teacher data is compared with an output value acquired when the data is input to the input layer, and an error of the two compared output values is fed back to the intermediate layer. This operation is repeated until the error falls below a predetermined threshold. By such the learning process, when the age estimated from the face image of the subject to be matched is input to the neural network (learning model), a value indicating the appropriate matching range (age group) in the face matching can be output.

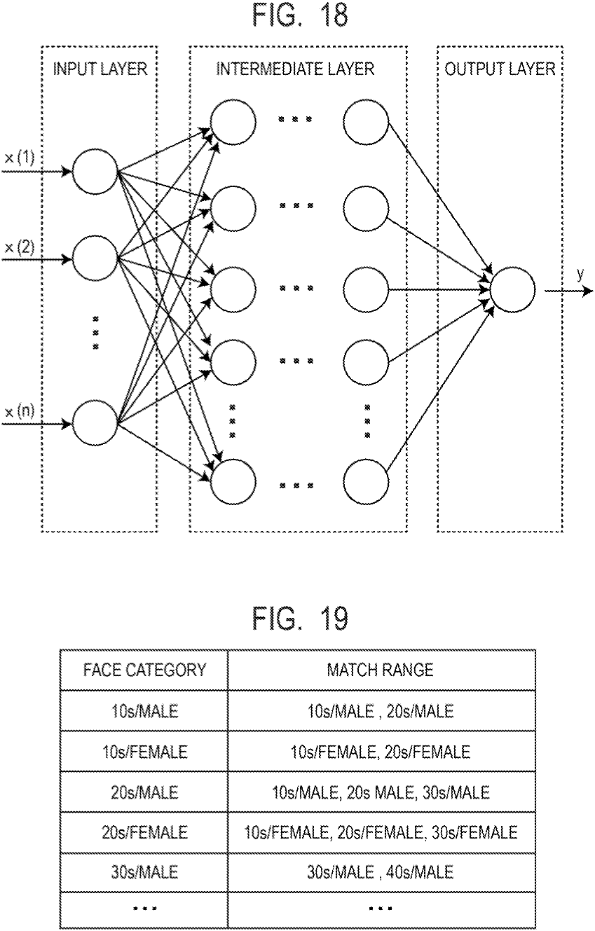

FIG. 19 is an example of a comparison table between the face category and the matching range according to this example embodiment. The comparison table indicates the relationship between the face category to which the attribute estimated from the face image of the subject to be matched belongs and the matching range output by the learning model when the face category is input. For example, when the attribute of the subject to be matched is estimated to be “18 years old male” from the face image, the face category is specified as “10s/Male”. In this case, an example is shown in which the learning model outputs not only “10s/Male” but also “20s/Male” as the face category of the matching range.

FIG. 20 is a flow chart showing a part of the matching process performed by the biometric authentication system according to this example embodiment. This process is performed, for example, between step S212 and step S216 in FIG. 11A described above.

In step S213, the management server 2 (specifying unit 212) determines whether there is a face category corresponding to the estimated attribute. Here, when the management server 2 determines that there is a face category corresponding to the attribute (step S213: YES), the management server 2 (specifying unit 212) specifies the face category (step S214). Then, the process proceeds to step S501.

In step S501, the management server 2 (learning unit 217) inputs the face category specified in step S214 into the learning model. In this way, the learning model outputs the face category to be the matching range with the face image of the subject to be matched.

In step S502, the management server 2 (learning unit 217) specifies the face category output from the learning model as a matching range with the face image of the subject to be matched. Then, the process proceeds to step S216.

On the other hand, when the management server 2 (specifying unit 212) determines that there is no face category corresponding to the attribute (step S213: NO), the management server 2 specifies the face category as “Other” (step S215). That is, because the attribute acquired from the face images of the subject to be matched cannot be classified into a predetermined face category, the attribute is classified into the face category “Other” which is the classification destination for exceptional features. Then, the process proceeds to step S216.

As described above, in this example embodiment, the matching range of the face image can be automatically updated to an appropriate range based on the learning model created by machine learning. Thus, in addition to the same effect as that of the first example embodiment, this has the effect of further improving the matching accuracy of face matching.

### Fifth Example Embodiment

The fifth example embodiment will be described below. Since this example embodiment is a variation of the first example embodiment, the same elements as the first example embodiment may be omitted or simplified.

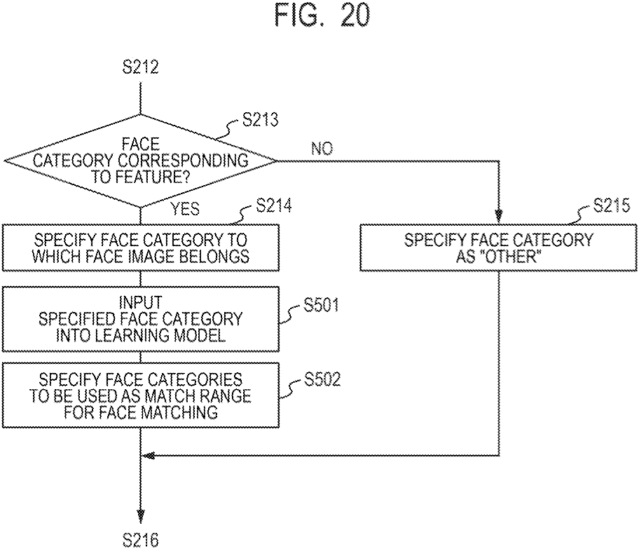

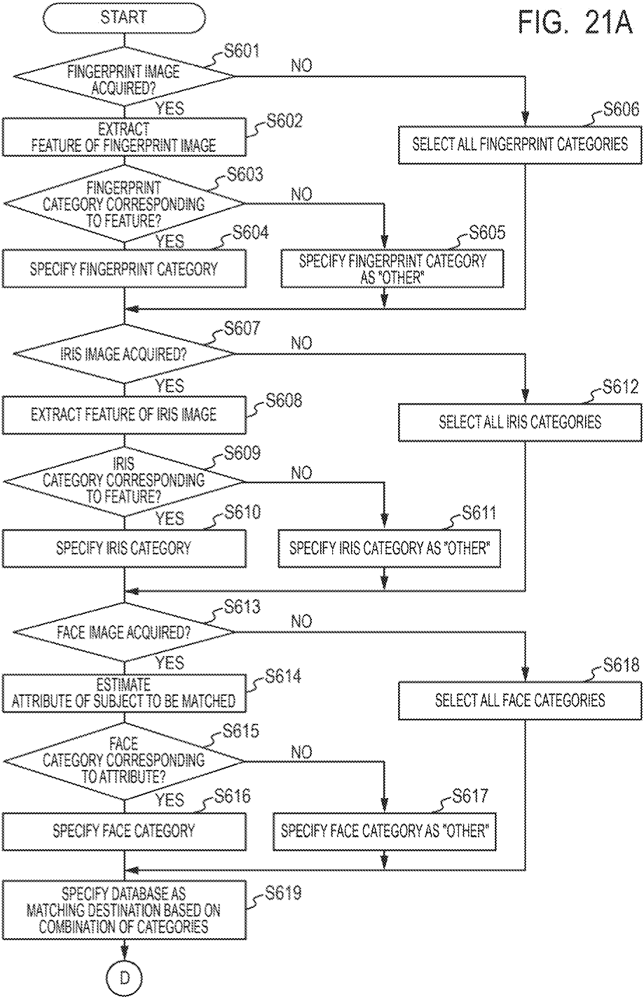

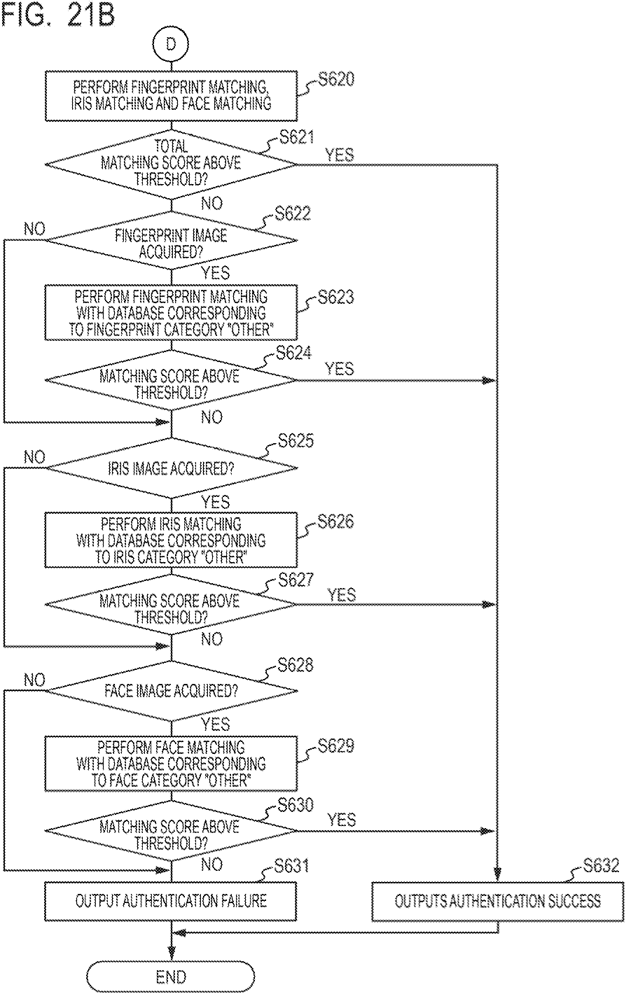

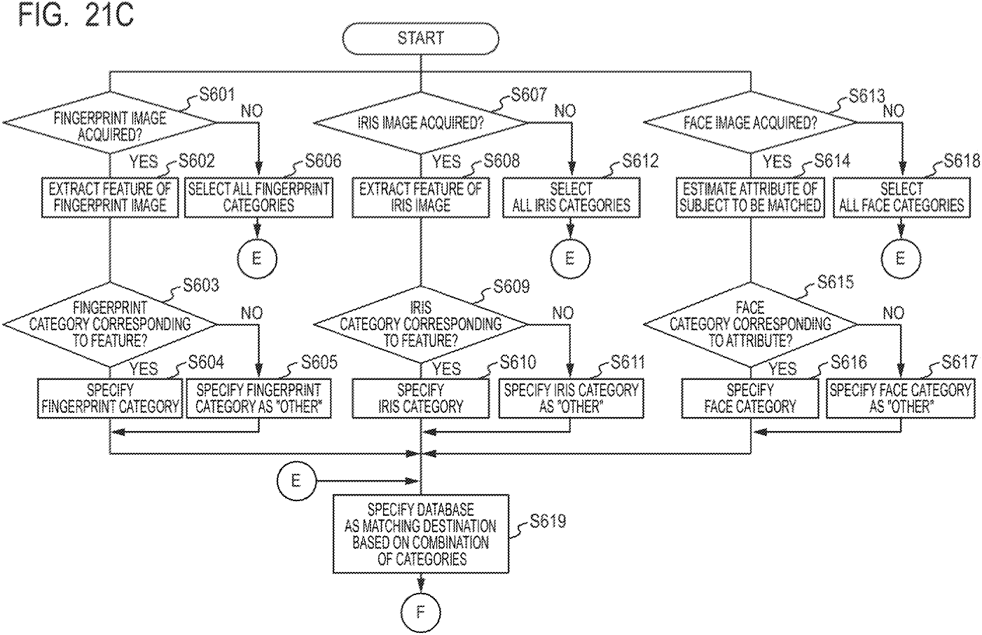

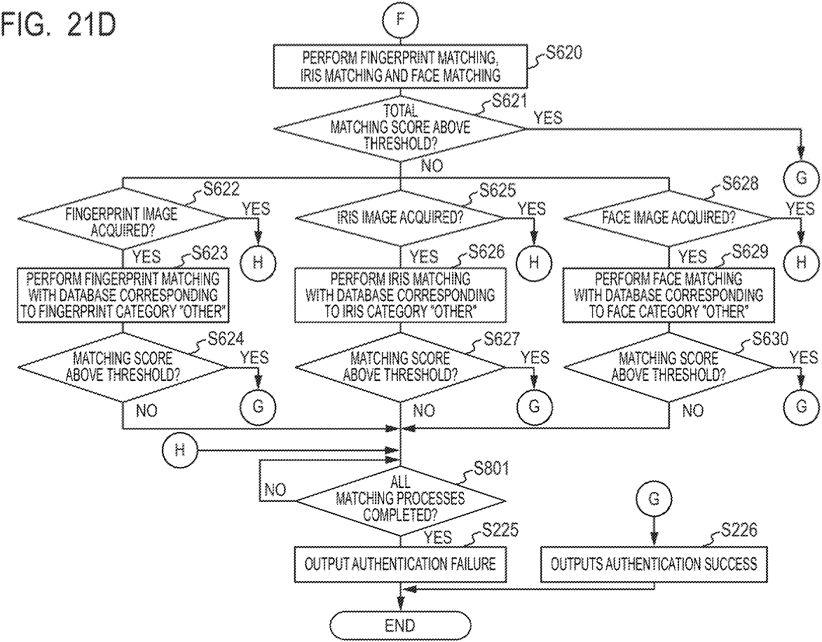

FIGS. 21A and 21B are flowcharts showing an outline of the matching process performed by the biometric authentication system according to this example embodiment.

In step S601, the management server 2 (specifying unit 212) determines whether or not the fingerprint image of the subject to be matched has been acquired in the biometric image acquisition apparatus 1. Here, when the management server 2 (specifying unit 212) determines that the fingerprint image of the subject to be matched has been acquired (step S601: YES), the process proceeds to step S602.

On the other hand, when the management server 2 (specifying unit 212) determines that the fingerprint image of the subject to be matched has not been acquired (step S601: NO), the process proceeds to step S606.

In step S602, the management server 2 (specifying unit 212) performs an image analysis of the fingerprint image acquired from the biometric image acquisition apparatus 1 and extracts a feature of the fingerprint image.

In step S603, the management server 2 (specifying unit 212) determines whether there is a fingerprint category corresponding to the extracted feature. Here, when the management server 2 determines that there is a fingerprint category corresponding to the feature (step S603: YES), the management server 2 (specifying unit 212) specifies the fingerprint category (step S604). Then, the process proceeds to step S607.

On the other hand, when the management server 2 (specifying unit 212) determines that there is no fingerprint category corresponding to the feature (step S603: NO), the management server 2 specifies the fingerprint category as “Other” (step S605). That is, when the feature extracted from the fingerprint image of the subject to be matched cannot be classified into the predetermined fingerprint category, the feature is classified into the fingerprint category “Other” which is the classification destination for the exceptional feature. Then, the process proceeds to step S607.

In step S606, the management server 2 (specifying unit 212) selects all fingerprint categories. Then, the process proceeds to step S607.

In step S607, the management server 2 (specifying unit 212) determines whether or not the iris image of the subject to be matched has been acquired by the biometric image acquisition apparatus 1. Here, when the management server 2 (specifying unit 212) determines that the iris image of the subject to be matched has been acquired (step S607: YES), the process proceeds to step S608.

On the other hand, when the management server 2 (specifying unit 212) determines that the iris image of the subject to be matched has not been acquired (step S607: NO), the process proceeds to step S612.

In step S608, the management server 2 (specifying unit 212) performs image analysis on the iris image acquired from the biometric image acquisition apparatus 1 and extracts a feature of the iris image.

In step S609, the management server 2 (specifying unit 212) determines whether there is an iris category corresponding to the extracted feature. When the management server 2 determines that there is an iris category corresponding to the feature (step S609: YES), the management server 2 (specifying unit 212) specifies the iris category (step S610). Then, the process proceeds to step S613.

On the other hand, when the management server 2 (specifying unit 212) determines that there is no iris category corresponding to the feature (step S609: NO), the management server 2 specifies the iris category as “Other” (step S611). That is, when the feature extracted from the iris image of the subject to be matched cannot be classified into a predetermined iris category, the feature is classified into the iris category “Other” which is the classification destination for exceptional features. Then, the process proceeds to step S613.

In step S613, the management server 2 (specifying unit 212) determines whether or not the face image of the subject to be matched has been acquired in the biometric image acquisition apparatus 1. Here, when the management server 2 (specifying unit 212) determines that the face image of the subject to be matched has been acquired (step S613: YES), the process proceeds to step S614.

On the other hand, when the management server 2 (specifying unit 212) determines that the face image of the subject to be matched has not been acquired (step S613: NO), the process proceeds to step S618.

In step S614, the management server 2 (specifying unit 212) performs image analysis on the face image received from the biometric image acquisition apparatus 1. Upon extracting the features of the face image, the management server 2 estimates the attribute (age and gender) of the subject to be matched based on the feature.

In step S615, the management server 2 (specifying unit 212) determines whether there is a face category corresponding to the estimated attribute. Here, when the management server 2 determines that there is a face category corresponding to the attribute (step S615: YES), the management server 2 (specifying unit 212) specifies the face category (step S616). Then, the process proceeds to step S619.

On the other hand, when the management server 2 (specifying unit 212) determines that there is no face category corresponding to the attribute (step S615: NO), the management server 2 specifies the face category as “Other” (step S617). That is, because the attribute acquired from the face images of the subject to be matched cannot be classified into a predetermined face category, the attribute is classified into the face category “Other” which is the classification destination for exceptional features. Then, the process proceeds to step S619.

In step S619, the management server 2 (matching unit 214) determines a matching destination database based on the combination of categories to which the fingerprint image, iris image and face image belong, respectively. Specifically, the management server 2 refers to the registration destination information DB 25 based on the combination, and selects one matching destination database from the N pieces of biometric information DBs 21.

In step S620, the management server 2 (matching unit 214) performs a fingerprint matching, an iris matching and a face matching related to the three types of biometric images acquired from the subject to be matched, respectively. For the biometric information among the fingerprint image, the iris image and the face image that has not been acquired from the subject to be matched, the matching process shall be omitted.

In step S621, the management server 2 (matching unit 214) determines whether there is a registrant whose total matching score is equal to or greater than the threshold in the biometric information DB 21 of the matching destination. Here, when the management server 2 determines that there is a registrant whose total matching score is equal to or greater than the threshold (step S621: YES), the process proceeds to step S632.

On the other hand, when the management server 2 (matching unit 214) determines that there is no registrant whose total matching score is equal to or greater than the threshold (step S621: NO), the process proceeds to step S622.

In step S622, the management server 2 (specifying unit 212) determines whether or not the fingerprint image of the subject to be matched has been acquired in the biometric image acquisition apparatus 1. Here, when the management server 2 (specifying unit 212) determines that the fingerprint image of the subject to be matched has been acquired (step S622: YES), the process proceeds to step S623.

On the other hand, when the management server 2 (specifying unit 212) determines that the fingerprint image of the subject to be matched has not been acquired (step S622: NO), the process proceeds to step S625.

In step S623, the management server 2 (matching unit 214) performs fingerprint matching on the fingerprint image of the subject to be matched with the biometric information DB 21 whose fingerprint category is “Other” as the matching destination.

In step S624, the management server 2 (matching unit 214) determines whether there is a registrant whose matching score in the fingerprint matching is equal to or greater than the threshold. Here, when the management server 2 determines that there is a registrant whose matching score in the fingerprint matching is equal to or greater than the threshold (step S624: YES), the process proceeds to step S632.

On the other hand, when the management server 2 (matching unit 214) determines that there is no registrant whose matching score in the fingerprint matching is equal to or greater than the threshold (step S624: NO), the process proceeds to step S625.

In step S625, the management server 2 (specifying unit 212) determines whether or not the iris image of the subject to be matched has been acquired by the biometric image acquisition apparatus 1. Here, when the management server 2 (specifying unit 212) determines that the iris image of the subject to be matched has been acquired (step S625: YES), the process proceeds to step S626.

On the other hand, when the management server 2 (specifying unit 212) determines that the iris image of the subject to be matched has not been acquired (step S625: NO), the process proceeds to step S628.

In step S626, the management server 2 (matching unit 214) performs an iris matching on the iris image of the subject to be matched with the biometric information DB 21 whose iris category is “Other” as the matching destination.

In step S627, the management server 2 (matching unit 214) determines whether there is a registrant whose matching score in the iris matching is equal to or greater than a threshold. Here, when the management server 2 (matching unit 214) determines that there is a registrant whose matching score in the iris matching is equal to or greater than the threshold (step S627: YES), the process proceeds to step S632.

On the other hand, when the management server 2 (matching unit 214) determines that there is no registrant whose matching score in the iris matching is equal to or greater than the threshold (step S627: NO), the process proceeds to step S628.

In step S628, the management server 2 (specifying unit 212) determines whether or not the face image of the subject to be matched has been acquired in the biometric image acquisition apparatus 1. Here, when the management server 2 (specifying unit 212) determines that the face image of the subject to be matched has been acquired (step S628: YES), the process proceeds to step S629.

On the other hand, when the management server 2 (specifying unit 212) determines that the face image of the subject to be matched has not been acquired (step S628: NO), the process proceeds to step S631.

In step S629, the management server 2 (matching unit 214) performs face matching on the face image of the subject to be matched with the biometric information DB 21 whose face category is “Other” as the matching destination.

In step S630, the management server 2 (matching unit 214) determines whether there is a registrant whose matching score in the face matching is equal to or greater than the threshold. Here, when the management server 2 (matching unit 214) determines that there is a registrant whose matching score in the face matching is equal to or greater than the threshold (step S630: YES), the process proceeds to step S632.

On the other hand, when the management server 2 (matching unit 214) determines that there is no registrant whose matching score in the face matching is equal to or greater than the threshold (step S630: NO), the process proceeds to step S631.

In step S631, the management server 2 (matching unit 214) assumes that there is no registrant matching the subject to be matched and outputs information of the authentication failure, and the process ends.

In step S632, the management server 2 (matching unit 214) assumes that the subject to be matched and the registrant are the same person, outputs information of the authentication success, and the process ends.

Noted that the process in the step S622 described above may be a process for determining whether or not the fingerprint matching has been performed in step S620. Similarly, the process in the step S625 may be a process for determining whether or not the iris matching has been performed in the step S620. The process in the step S628 may be a process for determining whether or not the face matching has been performed in the step S620.

Also, in FIG. 21A, the process for specifying the category of biometric information (steps S601 to S606/steps S607 to S612/steps S613 to S618) is performed in series in the order of the fingerprint, the iris, and the face. However, the order of the process is not limited to thereto. The process may be performed in the order of, for example, the face, the fingerprint, and the iris.

Similarly, in FIG. 21B, when the sum of the matching scores of the three types of matching process is less than a predetermined threshold (step S621: NO), the matching process and the determination process of the matching score using the biometric information DB 11 corresponding to the category “Other” as the matching destination are performed in series in the order of the fingerprint, the iris, and the face. However, the order of the process is not limited to thereto. The process may be performed in the order of, for example, the face, the fingerprint, and the iris.

The flowcharts in FIGS. 21A and 21B may be transformed into flowcharts of parallel processes as in FIGS. 21C and 21D, respectively. In FIG. 21C and FIG. 21D, the step numbers common to FIG. 21A and FIG. 21B are the same process, so a detailed description of each step is omitted.

In FIG. 21C, the specifying process of the fingerprint category (steps S601 to S606), the specifying process of the iris category (steps S607 to S612), and the specifying process of the face category (steps S613 to S618) are performed in parallel.

In FIG. 21D, when the sum of the matching scores of the three types of matching process is less than the threshold (step S621: NO), a group of processes for the fingerprint matching (step S622 to step S624), a group of processes for the iris matching (step S625 to step S627), and a group of processes for the face matching (step S628 to step S630) are performed in parallel.

Then, when all matching process performed in parallel is completed with “matching score: less than threshold” (step S801: YES), an authentication failure is output (step S631), and the process ends. On the other hand, when the matching score is not less than the threshold in any one of the matching processes performed in parallel (step S624: YES/step S627: YES/step S630), the authentication success is output (step S632), and the process ends.

In addition, the flowcharts of FIGS. 21A-21D are free to vary combinations, for example, combinations of FIGS. 21A and 21D and combinations of FIGS. 21C and 21B. That is, at least one of the specifying process of categories of biometric information and the process related to matching (the determination process before matching/the matching process/determination process of the matching score) may be parallel.

As described above, in this example embodiment, when some of the three types of biometric information could not be acquired, all categories are selected for the type of biometric information that could not be acquired. Thus, for example, even if only two types of biometric information among the three types of biometric information could be acquired from the subject to be matched, the matching process for the appropriate matching destination can be performed by using the combination of categories to which the acquired types of biometric information belong. That is, when only a fingerprint image (fingerprint category: “Spiral”) and a face image (face category: “20s/Male”) are acquired from a subject to be matched and the iris image is not acquired, the fingerprint matching and the face matching can be performed on the matching destination reduced by a combination of the fingerprint category and the face category (fingerprint category: “Spiral” + face category: “20s/Male” + iris category: unspecified).

### Sixth Example Embodiment

FIG. 22 is a functional block diagram of the information processing apparatus 100 according to the sixth example embodiment. The information processing apparatus 100 includes an acquisition unit 100A, a specifying unit 100B, and a registration unit 100C. The acquisition unit 100A acquires, from a subject to be registered, a plurality of biometric information whose type differ from each other. The specifying unit 100B specifies, based on features of each of the plurality of biometric information, a category to which each of the plurality of the biometric information belongs, among a plurality of categories set for each of the types. The registration unit 100C registers, in the storage area in association with each of the subjects to be registered, the plurality of biometric information and the categories to which the plurality of biometric information belong respectively.

According to this example embodiment, there is provided an information processing apparatus 100 that can improve the matching speed in multimodal biometric authentication.

### Seventh Example Embodiment

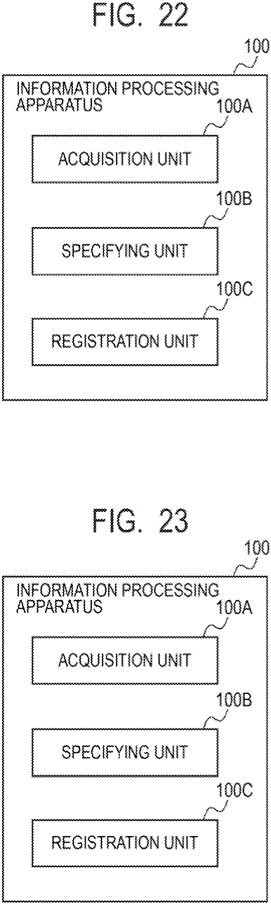

FIG. 23 is a functional block diagram of the information processing apparatus 100 according to the seventh embodiment. The information processing apparatus 100 according to this example embodiment has the following configuration in addition to the configuration of the sixth example embodiment. The specifying unit 100B in this example embodiment extracts the feature different from a feature amount that is extracted for each type in a matching process of the plurality of biometric information.

According to this example embodiment, in addition to the effect of the sixth example embodiment, there is provided an information processing apparatus 100 that can easily and quickly classify and register the biometric information of a person to be registered by an index different from the feature amount calculated at the time of the matching process of the biometric information. For example, when the color of the iris of a subject to be registered is extracted as a feature, only the pixel value of the iris area needs to be discriminated, so the process can be faster than calculating the feature amount of the iris. Furthermore, a feature different from the feature amount is set in association with a category that can be specified with the naked eye by an administrator or the like. Thereby, it is possible to easily determine whether biometric information of a different category is mistakenly registered in another category in the storage area.

### Eighth Example Embodiment

The information processing apparatus 100 according to this example embodiment has the following configuration in addition to the configuration of the sixth or seventh embodiment. The plurality of categories in this example embodiment include a first category that is predefined with respect to the features and a second category indicating that the feature does not apply to the first category.

According to this example embodiment, in addition to the effect of the sixth or seventh embodiment, there is provided an information processing apparatus 100 that can specify the category of the feature as the second category even when the feature extracted from the biometric information does not apply the first category. As a result, it is possible to deal with any features extracted from the biometric information, so that the biometric information DB 21 as the registration destination can be determined based on the combination of categories.

### Ninth Example Embodimen

The information processing apparatus 100 according to this example embodiment has the following configuration in addition to any of the configurations from the sixth to the eighth embodiment. In this example embodiment, a plurality of subcategories to subdivide the features is predefined in the category. In addition, the registration unit 100C performs, with respect to the category in which the number of registrants is associated beyond a predetermined threshold, an update process to associate, for each of the subject to be registered, the plurality of biometric information with the subcategories to which the plurality of biometric information belong respectively among the plurality of subcategories.

According to this example embodiment, in addition to any of the effects of the sixth to eighth embodiments, there is provided an information processing apparatus 100 that can update the biometric information DB 21 so that the category is divided into subcategories, when the number of registrants belonging to a category increases. Thereby, it is possible to suppress the speed decrease in the matching process of biometric information associated with the enlargement of the biometric information DB 21.

### Tenth Example Embodiment

FIG. 24 is a functional block diagram of the information processing apparatus 100 according to the tenth example embodiment. The information processing apparatus 100 according to this example embodiment further includes an output unit 100D in addition to the information processing apparatus 100 of any of the sixth to eighth embodiment. The output unit 100D in this example embodiment outputs alert information for prompting subdivision of the category when the number of registrants belonging to the category exceeds a predetermined threshold.

According to this example embodiment, in addition to any of the effects of the sixth to eighth embodiments, there is provided an information processing apparatus 100 that can notify the administrator of the biometric information DB 21 or the like of information in the biometric information DB 21 that has enlarged to a certain level or more. By prompting administrators and others to update the database, it is possible to suppress the speed decrease in the matching process of biometric information associated with the enlargement of the biometric information DB 21.

### Eleventh Example Embodiment

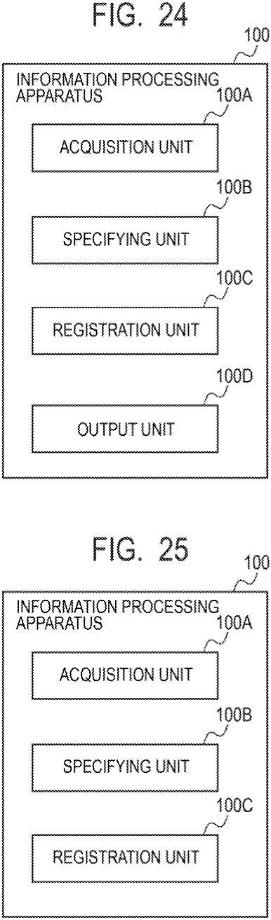

FIG. 25 is a functional block diagram of the information processing apparatus 100 according to the eleventh example embodiment. The information processing apparatus 100 according to this example embodiment has the following configuration in addition to any of the configurations of the sixth to tenth example embodiments. The specifying unit 100B in this example embodiment specifies the category based on at least one of shape, color, and luminance determined by an image analysis process for each of the plurality of biometric information.

According to this example embodiment, in addition to any of the effects of the sixth to tenth example embodiments, there is provided an information processing apparatus 100 that can specify and register categories for classifying biometric information based on appearance features such as shape, color and luminance. Since biometric information having common appearance features is registered in the storage area so as to belong to the same category, the matching speed in the matching process can be improved.

### [Twelfth Example Embodiment]

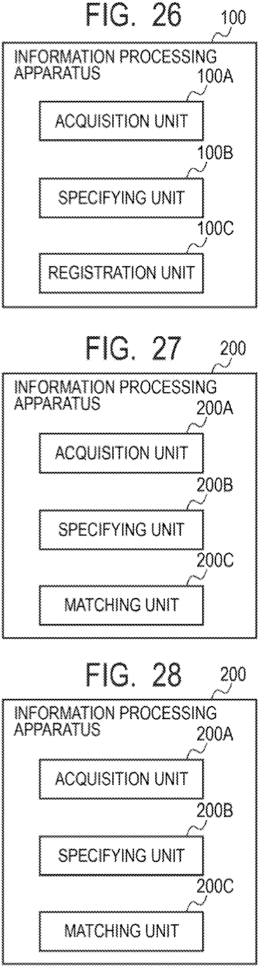

FIG. 26 is a functional block diagram of the information processing apparatus 100 according to the twelfth example embodiment. The information processing apparatus 100 according to this example embodiment has the following configuration in addition to any of the configurations of the sixth to eleventh example embodiments. The specifying unit 100B in this example embodiment specifies the category based on at least one of an age and a gender of the subject to be registered estimated from the feature of each of face images, when the plurality of biometric information are face images.

According to this example embodiment, in addition to any of the effects of the sixth to eleventh example embodiments, there is provided an information processing apparatus 100 that can classify and register the face image of the subject to be registered based on attribute information such as age and gender estimated from the face images. Since biometric information having common appearance feature (attribute) is registered in the storage area so as to belong to the same category, the matching speed in the matching process can be improved.

### [Thirteenth Example Embodiment]

The information processing apparatus 100 according to this example embodiment has the following configuration in addition to any of the configurations of the sixth to twelfth embodiments. The plurality of biometric information in this example embodiment include a biometric image.

According to this example embodiment, in addition to any of the effects of the sixth to twelfth example embodiments, there is provided an information processing apparatus 100 that can extract external features from a captured biometric image of a subject to be registered and register the biometric image.

### Fourteenth Example Embodiment

The information processing apparatus 100 according to this example embodiment has the following configuration in addition to the configuration of the thirteenth embodiment. The biometric image in this example embodiment includes at least two of a fingerprint image, an iris image, and a face image.

According to this example embodiment, in addition to the effect of the thirteenth example embodiment, there is provided an information processing apparatus 100 that can combine two or more biometric images to register the biometric images for each subject to be registered.

### Fifteenth Example Embodiment

FIG. 27 is a functional block diagram of the information processing apparatus 200 according to the fifteenth example embodiment. The information processing apparatus 200 includes an acquisition unit 200A, a specifying unit 200B, and a matching unit 200C. The acquisition unit 200A acquires, from a subject to be matched, a plurality of biometric information whose type differ from each other. The specifying unit 200B specifies, based on features of each of the plurality of biometric information, a category to which each of the plurality of the biometric information belongs, among a plurality of categories set for each of the types. The matching unit 200C determines a matching destination based on the specified categories by the specifying unit 200B, and performs a matching process between the plurality of biometric information and the plurality of registered biometric information of the registrant for each of the types.

According to this example embodiment, there is provided an information processing apparatus 200 that can improve the matching speed in multimodal biometric authentication.

### Sixteenth Example Embodiment

The information processing apparatus 200 according to this example embodiment has the following configuration in addition to the configuration of the fifteenth example embodiment. When the registrant information associates, for each registrant, the plurality of registered biometric information with the categories that the plurality of registered biometric information belongs to, the matching unit 200C performs the matching process, among registrant information, for the matching destination whose categories match in all the categories specified for each type by the specifying unit 200B.

According to this example embodiment, in addition to the effect of the fifteenth example embodiment, there is provided an information processing apparatus 200 that can perform a matching process on the condition that the biometric information of the subject to be matched and the registered biometric information of the registrant belong to a common category in all types. The matching speed in the matching process can be improved by surely reducing the number of the matching destinations.

### Seventeenth Example Embodiment

FIG. 28 is a functional block diagram of the information processing apparatus 200 according to the seventeenth example embodiment. In addition to the configuration of the fifteenth or sixteenth example embodiment, the information processing apparatus 200 according to this example embodiment has the following configuration. The specifying unit 200B in this example embodiment extracts the feature different from a feature amount that is extracted for each type in a matching process of the plurality of biometric information.

According to this example embodiment, in addition to the effect of the fifteenth or sixteenth example embodiment, there is provided an information processing apparatus 200 that can easily and rapidly classify the biometric information of the subject to be matched and execute the matching process by an index different from the feature amount calculated in the matching process of the biometric information. For example, when the color of the iris of the subject to be matched is extracted as a feature, only the pixel value of the iris region needs to be discriminated, and therefore faster processing than calculating the feature amount of the iris can be expected.

### Eighteenth Example Embodiment

The information processing apparatus 200 according to this example embodiment has the following configuration in addition to any of the configurations of the fifteenth to seventeenth example embodiment. When the plurality of biometric information includes a face image, the specifying unit 200B in this example embodiment specifies the matching range, based on a learning model that has learned a relationship between the category specified from the face image and a matching range for a face matching.

According to this example embodiment, in addition to any of the effects of the fifteenth to seventeenth example embodiments, there is provided an information processing apparatus 200 that can flexibly change the matching destination. Moreover, by repeatedly learning the learning model based on the input data and the output data in the matching process, this has the effect of specifying the matching destination with higher accuracy.

### Nineteenth Example Embodiment

The information processing apparatus 200 according to this example embodiment has the following configuration in addition to any of the configurations of the fifteenth to seventeenth example embodiments. When the plurality of biometric information includes a face image, based on a comparison table that predefines a relationship between the category specified from the face image and a matching range of a face matching, the specifying unit 200B in this example embodiment specifies the matching range.

According to this example embodiment, in addition to any of the effects of the fifteenth to seventeenth example embodiments, there is provided an information processing apparatus 200 that can flexibly change the matching destination. For example, even when it is difficult to accurately estimate an age from a face image, by defining the matching range on the comparison table within a highly probable range, the matching process can be performed for an appropriate age group.

### Twentieth Example Embodiment

The information processing apparatus 200 according to this example embodiment has the following configuration in addition to any of the configurations of the fifteenth to nineteenth example embodiments. The matching unit 200C in this example embodiment selects all categories with respect to the type that could not be acquired by the acquisition unit 200A among the plurality of biometric information.

According to this example embodiment, in addition to any of the effects of the fifteenth to nineteenth example embodiments, there is provided an information processing apparatus 200 that can perform a matching process in a state in which the matching destination is narrowed down even when it is not possible to acquire any type of biometric information among a plurality of biometric information of different types from each other. For example, when the iris image of the subject to be matched is not acquired in multimodal authentication using the fingerprint image, the iris image and the face image, all iris categories are selected without specifying one iris category in the iris image. In this case as well, since the category is specified for the fingerprint image and the face image, the matching destination can be narrowed down to improve the matching speed in the matching process.

### Twenty-first Example Embodiment

FIG. 29 is a functional block diagram of the information processing apparatus 200 according to the twenty-first example embodiment. The information processing apparatus 200 according to this example embodiment has the following configuration in addition to any of the configurations of fifteenth to twentieth example embodiments. The specifying unit 200B in this example embodiment specifies the category based on at least one of shape, color, and luminance determined by an analysis process for each of the plurality of biometric information.

According to this example embodiment, in addition to any of the effects of the fifteenth to twentieth example embodiments, there is provided an information processing apparatus 200 that can specify categories for classifying biometric information based on appearance features such as shape, color and luminance to perform a matching process. Since the matching destination can be narrowed down based on the determined features, the matching speed in the matching process can be improved.

### Twenty-second Example Embodiment

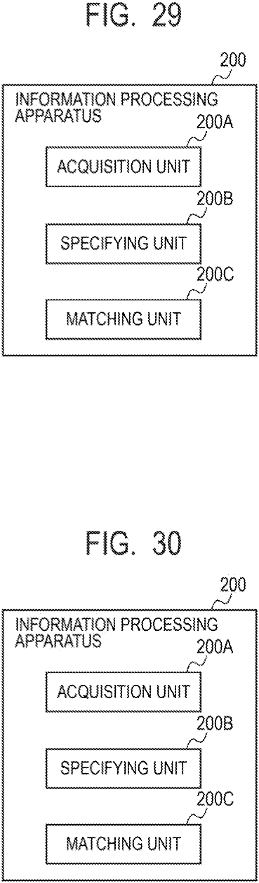

FIG. 30 is a functional block diagram of the information processing apparatus 200 according to the twenty-second example embodiments. The information processing apparatus 200 according to this example embodiment has the following configuration in addition to any of the configurations of the fifteenth to twenty-first example embodiments. When the plurality of biometric information are face images, the specifying unit 200B in this example embodiment specifies the category based on at least one of an age and a gender of the subject to be matched estimated from the feature of the face image.

According to this example embodiment, in addition to any of the effects of the fifteenth to twenty-first example embodiments, there is provided an information processing apparatus 200 that can perform a matching process on the face image of the subject to be registered based on attribute information such as the age and gender estimated from the face image. Since the matching destination can be narrowed down based on the estimated age and gender, the matching speed in the matching process can be improved.

### Twenty-third Example Embodiment

FIG. 31 is a functional block diagram of the information processing apparatus 200 according to the twenty-third example embodiment. The information processing apparatus 200 according to this example embodiment is further provided with a plurality of storage units 200D in addition to the information processing apparatus 200 of any of the fifteenth to twenty-second embodiments. The plurality of storage units 200D in this example embodiment store the plurality of registered biometric information in a distributed manner for each combination of categories to which the plurality of registered biometric information belong respectively.

According to this example embodiment, in addition to any of the effects of the fifteenth to twenty-second example embodiments, by providing a plurality of storage units 200D corresponding to the combination of categories related to the registered biometric information of the registrant, when the combination of categories related to the biometric information of the subject to be matched is specified, there is provided an information processing apparatus 200 that can be narrowed down to one storage unit 200 D as the matching destination.

### Twenty-fourth Example Embodiment

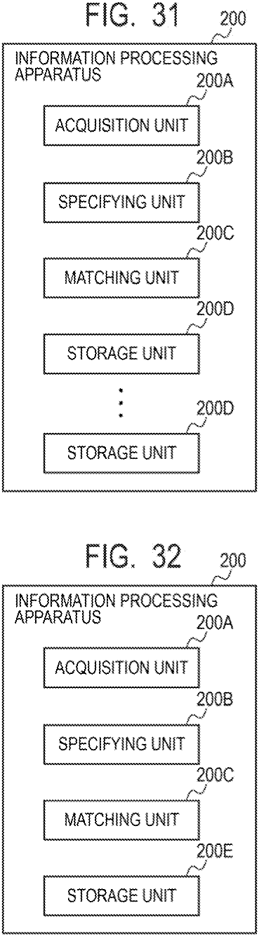

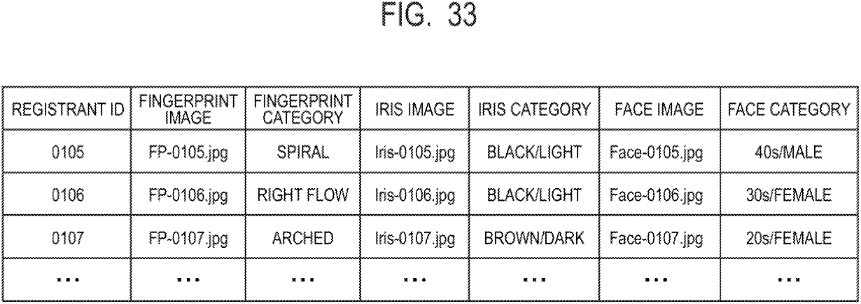

FIG. 32 is a functional block diagram of the information processing apparatus 200 according to the twenty-fourth example embodiment. The information processing apparatus 200 according to this example embodiment further includes a storage unit 200E in addition to the information processing apparatus 200 of any of the fifteenth to twenty-second embodiments. The storage unit 100E in this example embodiment unitarily stores the plurality of registered biometric information and the categories to which the plurality of registered biometric information belong respectively in association with each registrant.

According to this example embodiment, in addition to any of the effects of the fifteenth to twenty-second example embodiments, there is provided an information processing apparatus 200 that can centrally manage the registered biometric information of all registrants in the state where the registered biometric information are classified into categories by type.

### Twenty-fifth Example Embodiment

The information processing apparatus 200 according to this example embodiment has the following configuration in addition to any of the configurations of the fifteenth to twenty-fourth example embodiments. The plurality of biometric information in this example embodiment include a biometric image.

According to this example embodiment, in addition to any of the effects of the fifteenth to twenty-fourth example embodiments, there is provided an information processing apparatus 200 that can extract external features from a captured biometric image of a subject to be matched and perform the matching process.

### Twenty-sixth Example Embodiment

The information processing apparatus 200 according to this example embodiment has the following configuration in addition to the configuration of the twenty-fifth example embodiment. The biometric image in this example embodiment includes at least two of a fingerprint image, an iris image, and a face image.

According to this example embodiment, in addition to the effect of the twenty-fifth example embodiment, there is provided an information processing apparatus 200 that can combine two or more biometric images and perform the matching process.

### Modified Example Embodiment

This disclosure is not limited to the example embodiments described above and can be changed as appropriate within the scope not departing from the spirit of this disclosure. For example, an example in which a configuration of a part of any of the example embodiments is added to another example embodiment or an example in which a configuration of a part of any of the example embodiments is replaced with a configuration of a part of another example embodiment is also an example embodiment of this disclosure.

In each of the above examples, three types of biometric information were used: a fingerprint image, an iris image, and a fingerprint image. However, these types of biometric information are only examples and are not limited to the examples. Biometric information other than images may also be used.

In each of the above examples, the configuration in which the registered biometric information of a certain registrant is registered only in the database corresponding to the category combination among the N pieces of biometric information DBs 21 is described. However, the N pieces of biometric information DBs 21 may be constructed as a single database that centrally stores the registered biometric information of all registrants.

FIG. 33 is a diagram showing an example of information stored in the biometric information DB 21 according to the modified embodiment. The biometric information DB 21 shown in FIG. 33 differs from the biometric information DB 21 shown in FIG. 4 in further including the fingerprint category, the iris category, and the face category as data items. Even when the biometric information DB 21 is constructed as a single database, by associating and storing each biometric information and category as shown in FIG. 33, the same effect as the embodiment described above is achieved.

In the fourth example embodiment described above, the configuration for determining the matching range at the time of face matching using the learning model is described. However, instead of using the learning model, the configuration may use a comparison table as shown in FIG. 19 prepared in advance by the administrator or the like. In this case, the management server 2 (matching unit 214) can determine the matching range in the face matching by referring to the comparison table based on the estimated attribute.

The scope of each of the example embodiments also includes a processing method that stores, in a storage medium, a program that causes the configuration of each of the example embodiments to operate so as to implement the function of each of the example embodiments described above, reads the program stored in the storage medium as a code, and executes the program in a computer. That is, the scope of each of the example embodiments also includes a computer readable storage medium. Further, each of the example embodiments includes not only the storage medium in which the program described above is stored but also the individual program itself. Further, one or two or more components included in the example embodiments described above may be circuitry such as application specific integrated circuit (ASIC), field programmable gate array (FPGA), or the like configured to implement the function of each component.

As the storage medium, for example, a floppy (registered trademark) disk, a hard disk, an optical disk, a magneto-optical disk, a CD-ROM, a magnetic tape, a nonvolatile memory card, ROM, or the like can be used. Further, the scope of each of the example embodiments also includes an example that operates on an operating system (OS) to perform a process in cooperation with another software or a function of an add-in board without being limited to an example that performs a process by an individual program stored in the storage medium.

The services realized by the functions of each of the above embodiment can also be provided to the user in the form of Software as a Service (SaaS).

Note that all the example embodiments described above are to simply illustrate embodied examples in implementing this disclosure, and the technical scope of this disclosure should not be construed in a limiting sense by those example embodiments. That is, this disclosure can be implemented in various forms without departing from the technical concept or the primary feature thereof.

The whole or part of the example embodiments disclosed above can be described as, but not limited to, the following supplementary notes.

### Supplementary Note 1

An information processing apparatus comprising:
an acquisition unit that acquires, from a subject to be registered, a plurality of biometric information whose type differ from each other;
a specifying unit that specifies, based on features of each of the plurality of biometric information, a category to which each of the plurality of the biometric information belongs, among a plurality of categories set for each of the types; and
a registration unit that registers, in the storage area in association with each of the subjects to be registered, the plurality of biometric information and the categories to which the plurality of biometric information belong respectively.

### Supplementary Note 2

The information processing apparatus according to supplementary note 1, wherein the specifying unit extracts the feature different from a feature amount that is extracted for each type in a matching process of the plurality of biometric information.

### Supplementary Note 3

The information processing apparatus according to supplementary note 1 or 2, wherein the plurality of categories include a first category that is predefined with respect to the features and a second category indicating that the feature does not apply to the first category.

### Supplementary Note 4

The information processing apparatus according to any one of supplementary notes 1 to 3, wherein a plurality of subcategories to subdivide the features is predefined in the category,

wherein the registration unit performs, with respect to the category in which the number of registrants is associated beyond a predetermined threshold, an update process to associate, for each of the subject to be registered, the plurality of biometric information with the subcategories to which the plurality of biometric information belong respectively among the plurality of subcategories.

### Supplementary Note 5

The information processing apparatus according to any one of supplementary notes 1 to 3, further comprising:

an output unit that outputs alert information for prompting subdivision of the category when the number of registrants belonging to the category exceeds a predetermined threshold.

### Supplementary Note 6

The information processing apparatus according to any one of supplementary notes 1 to 5, wherein the specifying unit specifies the category based on at least one of shape, color, and luminance determined by an image analysis process for each of the plurality of biometric information.

### Supplementary Note 7

The information processing apparatus according to any one of supplementary notes 1 to 6, wherein when the plurality of biometric information are face images, the specifying unit specifies the category based on at least one of an age and a gender of the subject to be registered estimated from the feature of each of face images.

### Supplementary Note 8

The information processing apparatus according to any one of supplementary notes 1 to 7, wherein the plurality of biometric information include a biometric image.

### Supplementary Note 9

The information processing apparatus according to supplementary note 8, wherein the biometric image includes at least two of a fingerprint image, an iris image, and a face image.

### Supplementary Note 10

An information processing method comprising:
acquiring, from a subject to be registered, a plurality of biometric information whose type differ from each other;
specifying, based on features of each of the plurality of biometric information, a category to which each of the plurality of the biometric information belongs, among a plurality of categories set for each of the types; and
registering, in the storage area in association with each of the subjects to be registered, the plurality of biometric information and the categories to which the plurality of biometric information belong respectively.

### Supplementary Note 11

A storage medium that stores a program for causing a computer to perform:
acquiring, from a subject to be registered, a plurality of biometric information whose type differ from each other;
specifying, based on features of each of the plurality of biometric information, a category to which each of the plurality of the biometric information belongs, among a plurality of categories set for each of the types; and
registering, in the storage area in association with each of the subjects to be registered, the plurality of biometric information and the categories to which the plurality of biometric information belong respectively.

### Supplementary Note 12

An information processing apparatus comprising:
an acquisition unit that acquires, from a subject to be matched, a plurality of biometric information whose type differ from each other;
a specifying unit that specifies, based on features of each of the plurality of biometric information, a category to which each of the plurality of the biometric information belongs, among a plurality of categories set for each of the types; and
a matching unit that determines a matching destination based on the specified categories by the specifying unit, and performs a matching process between the plurality of biometric information and the plurality of registered biometric information of the registrant for each of the types.

### Supplementary Note 13

The information processing apparatus according to supplementary note 12, wherein when the registrant information associates, for each registrant, the plurality of registered biometric information with the categories that the plurality of registered biometric information belongs to, the matching unit performs the matching process, among registrant information, for the matching destination whose categories match in all the categories specified for each type by the specifying unit.

### Supplementary Note 14

The information processing apparatus according to supplementary note 12 or 13, wherein the specifying unit extracts the feature different from a feature amount that is extracted for each type in a matching process of the plurality of biometric information.

### Supplementary Note 15

The information processing apparatus according to any one of supplementary notes 12 to 14, wherein when the plurality of biometric information includes a face image, based on a learning model that has learned a relationship between the category specified from the face image and a matching range for a face matching, the specifying unit specifies the matching range.

### Supplementary Note 16

The information processing apparatus according to any one of supplementary notes 12 to 14, wherein when the plurality of biometric information includes a face image, based on a comparison table that predefines a relationship between the category specified from the face image and a matching range of a face matching, the specifying unit specifies the matching range.

### Supplementary Note 17

The information processing apparatus according to any one of supplementary notes 12 to 16, wherein the matching unit selects all categories with respect to the type that could not be acquired by the acquisition unit among the plurality of biometric information.

### Supplementary Note 18

The information processing apparatus according to any one of supplementary notes 12 to 17, wherein the specifying unit specifies the category based on at least one of shape, color, and luminance determined by an analysis process for each of the plurality of biometric information.

### Supplementary Note 19

The information processing apparatus according to any one of supplementary notes 12 to 18, wherein when the plurality of biometric information are face images, the specifying unit specifies the category based on at least one of an age and a gender of the subject to be matched estimated from the feature of the face image.

### Supplementary Note 20

The information processing apparatus according to any one of supplementary notes 12 to 19, further comprising:

a plurality of storage units that store the plurality of registered biometric information in a distributed manner for each combination of categories to which the plurality of registered biometric information belong respectively.

### Supplementary Note 21

The information processing apparatus according to any one of supplementary notes 12 to 19, further comprising:

A storage unit that unitarily stores the plurality of registered biometric information and the categories to which the plurality of registered biometric information belong respectively in association with each registrant.

### Supplementary Note 22

The information processing apparatus according to any one of supplementary notes 12 to 21, wherein the plurality of biometric information include a biometric image.

### Supplementary Note 23

The information processing apparatus according to supplementary note 22, wherein the biometric image includes at least two of a fingerprint image, an iris image, and a face image.

### Supplementary Note 24

An information processing method comprising:
acquiring, from a subject to be matched, a plurality of biometric information whose type differ from each other;
specifying, based on features of each of the plurality of biometric information, a category to which each of the plurality of the biometric information belongs, among a plurality of categories set for each of the types; and
determining a matching destination based on the specified categories, and performing a matching process between the plurality of biometric information and the plurality of registered biometric information of the registrant for each of the types.

### Supplementary Note 25

A storage medium that stores a program for causing a computer to perform an information processing method, the information processing method comprising:
acquiring, from a subject to be matched, a plurality of biometric information whose type differ from each other;
specifying, based on features of each of the plurality of biometric information, a category to which each of the plurality of the biometric information belongs, among a plurality of categories set for each of the types; and
determining a matching destination based on the specified categories, and performing a matching process between the plurality of biometric information and the plurality of registered biometric information of the registrant for each of the types.

REFERENCE SIGNS LIST

| NW | network |
|---|---|
| 1 | biometric image acquisition apparatus |
| 2 | management server |
| 21 | biometric information DB |
| 22 | fingerprint category information DB |
| 23 | iris category information DB |
| 24 | face category information DB |
| 25 | registration destination information DB |
| 100, 200 | information processing apparatus |
| 100A, 200A | acquisition unit. |
| 100B, 200B | specifying unit |
| 100C | registration unit |
| 200C | matching unit |
| 101,201 | processor |
| 102,202 | RAM |
| 103,203 | ROM |
| 104,204 | HDD |
| 105,205 | communication I/F |
| 106 | operating device |
| 107 | imaging device |
| 107 a | visible light camera |
| 107 b | infrared camera |
| 108 | display device |
| 111 | display control unit |
| 112 | image acquisition unit. |
| 113 | I/F unit |
| 206 | input Device |
| 207 | output Device |
| 211 | I/F unit |
| 212 | specifying unit |
| 213 | registration unit |
| 214 | matching unit |
| 215 | storage unit |
| 216 | output unit |
| 217 | learning unit |

What is claimed is:

1. An information processing apparatus comprising:
an acquisition unit that acquires, from a subject to be registered, a plurality of biometric information whose type differ from each other;
a specifying unit that specifies, based on features of each of the plurality of biometric information, a category to which each of the plurality of the biometric information belongs, among a plurality of categories set for each of the types; and
a registration unit that registers, in the storage area in association with each of the subjects to be registered, the plurality of biometric information and the categories to which the plurality of biometric information belong respectively.

2. The information processing apparatus according to claim 1, wherein the specifying unit extracts the feature different from a feature amount that is extracted for each type in a matching process of the plurality of biometric information.

3. The information processing apparatus according to claim 1, wherein the plurality of categories include a first category that is predefined with respect to the features and a second category indicating that the feature does not apply to the first category.

4. The information processing apparatus according to claim 1, wherein a plurality of subcategories to subdivide the features is predefined in the category,
wherein the registration unit performs, with respect to the category in which the number of registrants is associated beyond a predetermined threshold, an update process to associate, for each of the subject to be registered, the plurality of biometric information with the subcategories to which the plurality of biometric information belong respectively among the plurality of subcategories.

5. The information processing apparatus according to claim 1, further comprising:
an output unit that outputs alert information for prompting subdivision of the category when the number of registrants belonging to the category exceeds a predetermined threshold.

6. The information processing apparatus according to claim 1, wherein the specifying unit specifies the category based on at least one of shape, color, and luminance determined by an image analysis process for each of the plurality of biometric information.

7. The information processing apparatus according to claim 1, wherein when the plurality of biometric information are face images, the specifying unit specifies the category based on at least one of an age and a gender of the subject to be registered estimated from the feature of each of face images.

8. The information processing apparatus according to claim 1, wherein the plurality of biometric information include a biometric image.

9. The information processing apparatus according to claim 8, wherein the biometric image includes at least two of a fingerprint image, an iris image, and a face image.

10. (canceled)

11. (canceled)

12. An information processing apparatus comprising:
an acquisition unit that acquires, from a subject to be matched, a plurality of biometric information whose type differ from each other;
a specifying unit that specifies, based on features of each of the plurality of biometric information, a category to which each of the plurality of the biometric information belongs, among a plurality of categories set for each of the types; and
a matching unit that determines a matching destination based on the specified categories by the specifying unit, and performs a matching process between the plurality of biometric information and the plurality of registered biometric information of the registrant for each of the types.

13. The information processing apparatus according to claim 12, wherein when the registrant information associates, for each registrant, the plurality of registered biometric information with the categories that the plurality of registered biometric information belongs to, the matching unit performs the matching process, among registrant information, for the matching destination whose categories match in all the categories specified for each type by the specifying unit.

14. The information processing apparatus according to claim 12, wherein the specifying unit extracts the feature different from a feature amount that is extracted for each type in a matching process of the plurality of biometric information.

15. The information processing apparatus according to claim 12, wherein when the plurality of biometric information includes a face image, based on a learning model that has learned a relationship between the category specified from the face image and a matching range for a face matching, the specifying unit specifies the matching range.

16. The information processing apparatus according to claim 12, wherein when the plurality of biometric information includes a face image, based on a comparison table that predefines a relationship between the category specified from the face image and a matching range of a face matching, the specifying unit specifies the matching range.

17. The information processing apparatus according to claim 12, wherein the matching unit selects all categories with respect to the type that could not be acquired by the acquisition unit among the plurality of biometric information.

18. The information processing apparatus according to claim 12, wherein the specifying unit specifies the category based on at least one of shape, color, and luminance determined by an analysis process for each of the plurality of biometric information.

19. The information processing apparatus according to claim 12, wherein when the plurality of biometric information are face images, the specifying unit specifies the category based on at least one of an age and a gender of the subject to be matched estimated from the feature of the face image.

20. The information processing apparatus according to claim 12, further comprising:
a plurality of storage units that store the plurality of registered biometric information in a distributed manner for each combination of categories to which the plurality of registered biometric information belong respectively.

21. The information processing apparatus according to claim 12, further comprising:
a storage unit that unitarily stores the plurality of registered biometric information and the categories to which the plurality of registered biometric information belong respectively in association with each registrant.

22. The information processing apparatus according to claim 12, wherein the plurality of biometric information include a biometric image.

23. (canceled)

24. (canceled)

25. (canceled)
